(19) United States
(12) Patent Application Publication
(10) Pub. No.: US 2026/0177425 A1
(43) Pub. Date: Jun. 25, 2026

(54) CONVERSION DEVICE AND CONVERSION SYSTEM INCLUDING CONVERSION DEVICE

(71) Applicant: CANON KABUSHIKI KAISHA, Tokyo (JP)

(72) Inventors: SHOGO YAMASAKI, Kanagawa (JP); HIROSHI SEKINE, Kanagawa (JP)

(21) Appl. No.: 19/418,761

(22) Filed: Dec. 12, 2025

(30) Foreign Application Priority Data
Dec. 23, 2024 (JP) 2024-226059

(51) Int. Cl. G01J 1/44; H04N 25/76; H04N 25/773; H04N 25/79

(52) U.S. Cl. CPC G01J 1/44; H04N 25/773; H04N 25/7795; H04N 25/79; G01J 2001/442

(57) ABSTRACT

Provided are a first controller, a generator, a measurer, and a second controller. The first controller generates a signal defining multiple second periods that are included in a first period corresponding to one frame and each of which is shorter than the first period. The generator generates a pulse signal that defines time information within each second period. The measurer counts the pulse signal at or after first photon detection in the second period based on the generated pulse signal. The second controller performs count control of the pulse signal in a subsequent second period to the second period based on a value of the measurer.

### BACKGROUND

### Field of the Technology

The aspect of embodiments relates to conversion devices, and to conversion systems including conversion devices.

### Description of the Related Art

PCT International Publication No. WO 2020/179928 discloses a configuration that measures the time until a counter for each pixel reaches saturation, and estimates the amount of light by an extrapolation method based on the measured time and the count value. With this configuration, it is possible to expand the dynamic range.

According to PCT International Publication No. WO 2020/179928, since the counter stops due to saturation, signal information subsequent to the stoppage of the counter is missing. This may result in, for example, artifacts during imaging of a mobile object or variations in brightness during imaging under a flickering light source.

### SUMMARY

A conversion device includes: a photoelectric conversion element configured to receive a photon; a first controller configured to generate a signal defining a plurality of second periods that are included in a first period corresponding to one frame, each second period being shorter than the first period; a generator configured to generate a pulse signal that defines time information within each second period; a measurer configured to count the pulse signal at or after first photon detection in the second period based on the generated pulse signal; and a second controller configured to perform count control of the pulse signal in a subsequent second period to the second period based on a value of the measurer, the subsequent second period being one of the plurality of second periods.

Features of the disclosure will become apparent from the following description of embodiments with reference to the attached drawings. The following description of embodiments is described by way of example.

### BRIEF DESCRIPTION OF THE DRAWINGS

FIG. 1 illustrates a configuration example of a pixel circuit.

FIGS. 2A and 2B illustrate the relationship between a detection time and the number of incident photons.

FIGS. 3A to 3C illustrate the relationship between the detection time and the number of incident photons.

FIGS. 4A to 4C illustrate a photon detection probability.

FIGS. 5A to 5C illustrate expectation values with respect to the number of incident photons and input-output characteristics.

FIG. 6 illustrates a photoelectric conversion device according to a first embodiment.

FIG. 7 illustrates the photoelectric conversion device according to the first embodiment.

FIG. 8 illustrates the photoelectric conversion device according to the first embodiment.

FIG. 9 illustrates the photoelectric conversion device according to the first embodiment.

FIGS. 10A to 10C illustrate a pixel circuit of the photoelectric conversion device according to the first embodiment, and driving thereof.

FIG. 11 illustrates an operation sequence of the photoelectric conversion device according to the first embodiment.

FIG. 12 illustrates a case where a clock signal defining time information has uniform intervals and nonuniform intervals.

FIGS. 13A and 13B illustrate the clock signal defining the time information and input-output characteristics.

FIGS. 14A and 14B illustrate a pixel circuit of a photoelectric conversion device according to a second embodiment.

FIG. 15 illustrates an operation sequence of the photoelectric conversion device according to the second embodiment.

FIG. 16 illustrates a pixel circuit of a photoelectric conversion device according to a third embodiment.

FIG. 17 illustrates an operation sequence of the photoelectric conversion device according to the third embodiment.

FIG. 18 illustrates advantageous effects of the photoelectric conversion device according to the third embodiment.

FIG. 19 illustrates a photoelectric conversion device according to a fourth embodiment.

FIG. 20 illustrates a pixel circuit of the photoelectric conversion device according to the fourth embodiment.

FIG. 21 illustrates signal processing blocks of a photoelectric conversion device according to a fifth embodiment.

FIGS. 22A and 22B are schematic views according to a sixth embodiment.

FIG. 23 is a functional block diagram of a photoelectric conversion system according to a seventh embodiment.

FIGS. 24A and 24B are functional block diagrams of a photoelectric conversion system according to an eighth embodiment.

FIG. 25 is a functional block diagram of a photoelectric conversion system according to a ninth embodiment.

FIG. 26 is a functional block diagram of a photoelectric conversion system according to a tenth embodiment.

FIGS. 27A and 27B are functional block diagrams of a photoelectric conversion system according to an eleventh embodiment.

### DESCRIPTION OF THE EMBODIMENTS

Embodiments to be described below are intended to embody the technical concept of the present disclosure and are not intended to limit the present disclosure. The sizes and positional relationships of members illustrated in the drawings may sometimes be exaggerated for the purpose of clarity of description. In the following description, identical components are given the same reference signs, and descriptions thereof may sometimes be omitted.

In the following description, terms indicating specific directions and positions (e.g., “above”, “below”, “rightward”, “leftward”, and other terms including these terms) are used, as appropriate. The use of these terms is intended for facilitating the understanding of the embodiments with reference to the drawings, and is not intended to limit the technical scope of the present disclosure.

In this description, “plan view” is a view from a direction perpendicular to the principal surface of a semiconductor layer, and is synonymous with “top view”. Furthermore, “cross-sectional view” is a view from a direction perpendicular to a plane extending in the direction perpendicular to the principal surface of the semiconductor layer.

In the following description, the anode of a photodiode (PD) is set to a fixed potential, and a signal is extracted from the cathode side. Therefore, a first-conductivity-type semiconductor region, in which electric charges of the same polarity as the signal charge serve as majority carriers, is an N-type semiconductor region, whereas a second-conductivity-type semiconductor region, in which electric charges of opposite polarity to the signal charge serve as majority carriers, is a P-type semiconductor region. Alternatively, the cathode of the PD may be set to a fixed potential, and a signal may be extracted from the anode side. In this case, the first-conductivity-type semiconductor region, in which electric charges of the same polarity as the signal charge serve as majority carriers, is a P-type semiconductor region, whereas the second-conductivity-type semiconductor region, in which electric charges of opposite polarity to the signal charge serve as majority carriers, is an N-type semiconductor region. Although the following description relates to a case where one of the nodes of the PD is set to a fixed potential, the potentials of both anodes may vary.

### Basic Configuration

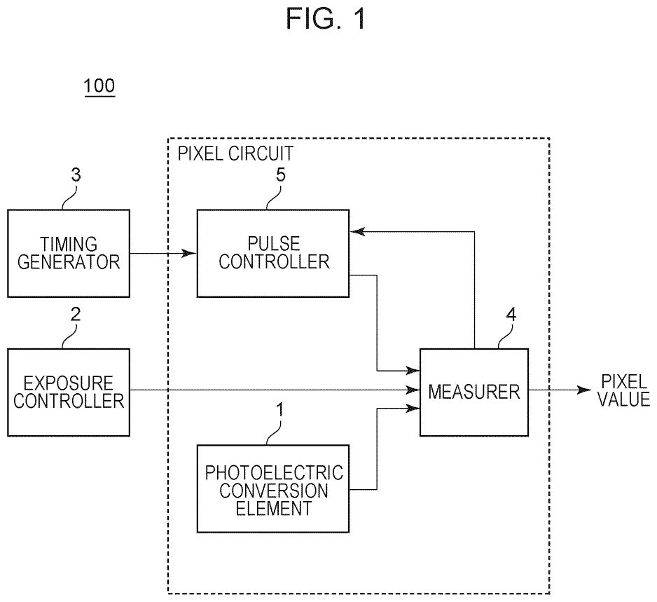

FIG. 1 illustrates a schematic configuration of a photoelectric conversion device according to this embodiment. A photoelectric conversion device 100 includes a photoelectric conversion element 1, an exposure controller 2, a timing generator 3, a measurer 4, and a pulse controller 5.

The photoelectric conversion element 1 detects an incident photon and converts the photon into an electrical signal. The photoelectric conversion element 1 may be a linear-mode avalanche photodiode operated around the breakdown voltage, or may be a single-photon avalanche photodiode operated in Geiger mode.

The exposure controller 2 generates a signal that defines an exposure period (first exposure period) corresponding to one frame. An “exposure period corresponding to one frame” may also be referred to as “one frame period”. The exposure controller 2 also generates a signal that defines an exposure period (second exposure period) corresponding to each of multiple sub-frames included in the exposure period corresponding to one frame. An “exposure period corresponding to a sub-frame” may also be referred to as “sub-frame period”.

The timing generator 3 generates a pulse signal for defining time information within the sub-frame period (i.e., within the second exposure period).

The measurer 4 receives a signal from the photoelectric conversion element 1, a control signal from the exposure controller 2, and a control signal from the timing generator 3 via the pulse controller 5. The measurer 4 measures a numerical value corresponding to a detection time of a photon detected first from the start of the sub-frame period from these signals. The measurer 4 used may be a generic time-to-digital converter (TDC) circuit serving as a circuit that performs time measurement, or may perform the measurement based on another method.

The pulse controller 5 receives a signal from the measurer 4 and a signal from the timing generator 3. The pulse controller 5 controls the number of control signals to be input to the measurer 4 based on the numerical value of the measurer 4.

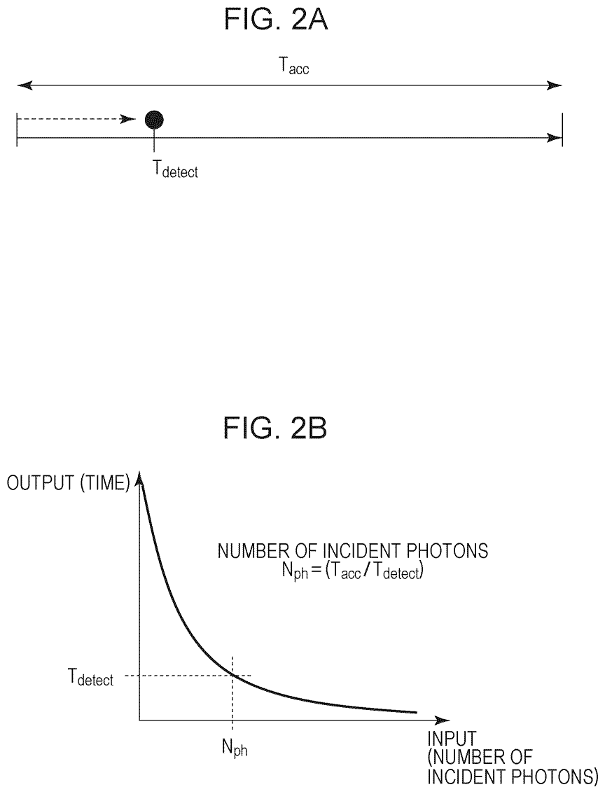

FIG. 2A illustrates the exposure period and the detection time, and FIG. 2B illustrates the relationship between the detection time and the number of incident photons.

When the exposure period is defined as T_{acc} and the time from the start of the exposure period to when a photon is detected is defined as T_{detect}, the number Nₚₕ of incident photons incident within the exposure period is expressed as: Nₚₕ=(T_{acc}/T_{detect}). Therefore, by ascertaining the exposure period and the detection time, the number of incident photons can be estimated. In other words, since the number of incident photons incident within the exposure period can be determined without having to actually measure the number of incident photons, imaging is possible.

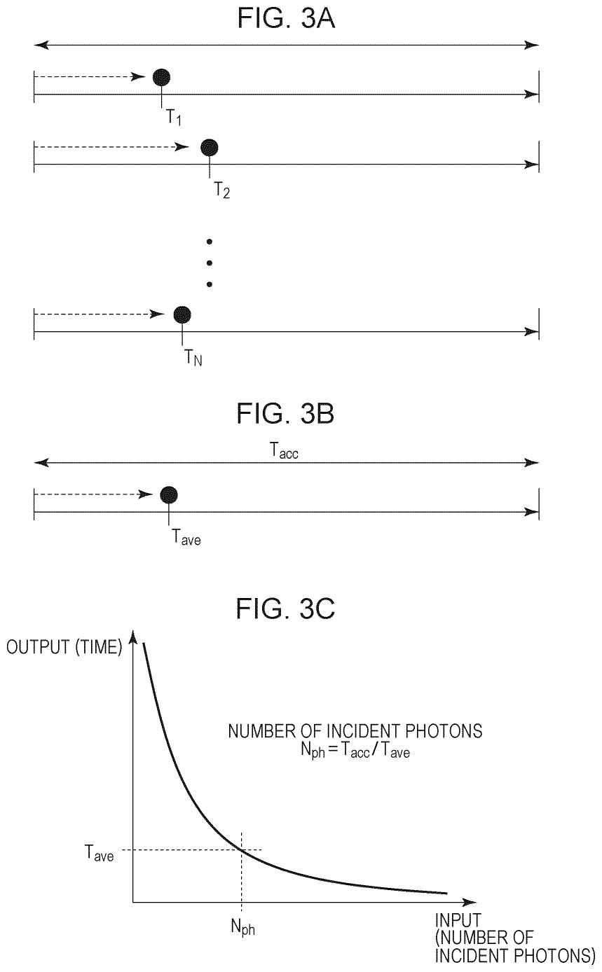

FIGS. 3A and 3B illustrate a case where the exposure illustrated in FIGS. 2A and 2B is performed multiple times. In this case, a measurement period per exposure is referred to as “sub-frame period”, and the sub-frame period is repeated N times. One frame period is the total sum from a first sub-frame to an N-th sub-frame. In this case, when an average of the time in which photons are detected in the sub-frames during one frame period is defined as Tₐᵥₑ, the number Nₚₕ of incident photons in one frame can be estimated as: Nₚₕ=(T_{acc}/Tₐᵥₑ). FIG. 3C illustrates a correspondence relationship between the average value of the detection time and the number of incident photons.

Although FIGS. 3A to 3C focus on the average photon detection time, the estimation of the number of incident photons is also possible from an integrated photon detection time. In addition, the averaging or integration process may be performed within the photoelectric conversion device 100, or may be performed in an external processing circuit by outputting a signal for every sub-frame externally from the photoelectric conversion device 100.

The aforementioned relational expression between the number of incident photons and the detection time is suitable when a minimum unit of the detection time is sufficiently smaller than the photon detection time, but may have an effect when the minimum unit of the detection time is about the same as the photon detection time. For example, since the expected number of incident photons may originally vary depending on the timing of detection even within the minimum unit of the detection time, the above relational expression may produce an error.

A situation where such an error is not negligible is expressed as a situation where the detection time is discretely affected.

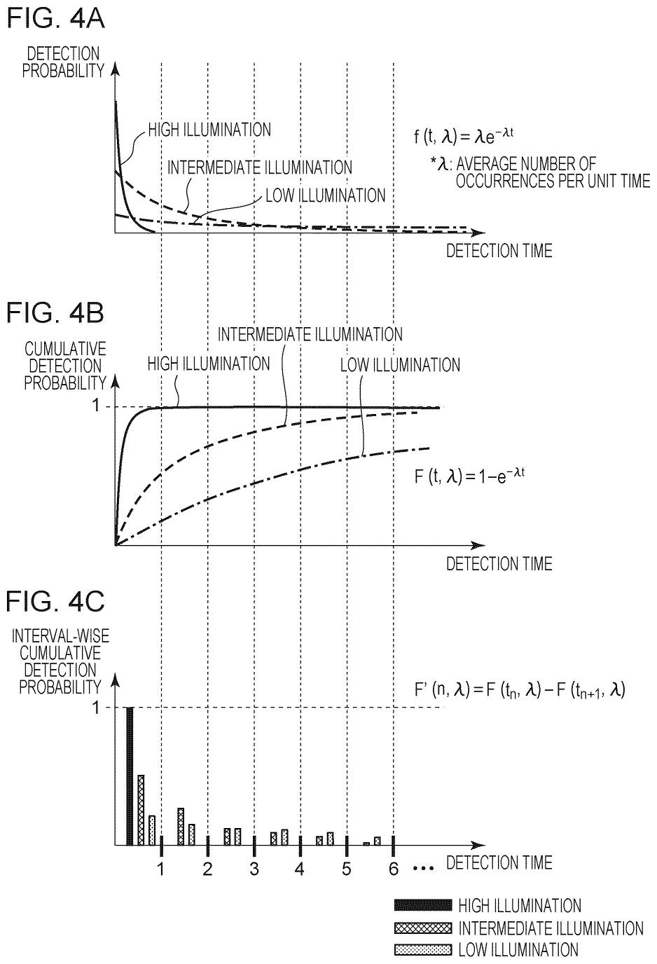

FIGS. 4A to 4C relate to an estimation of the number of photons when the detection time is regarded as discrete.

FIGS. 4A to 4C schematically illustrate a photon detection probability. When the detection time is defined as 1, 2, and so on, a photon detection probability at a certain time is known to accord with an exponential distribution (f (t, λ)=λe^{-λt}, where a is the number of events per unit time). In this case, 2 is a value determined based on the number Nₚₕ of incident photons, the exposure time, and the unit time (i.e., the minimum unit of the detection time). In detail, 2 is equal to (number of incident photons/exposure time)×(unit time). For example, assuming that the number of incident photons is 1, the exposure time is 1000, and the unit time is 1, ( 1/1000)×1, so that 2 is equal to 0.001. According to this exponential function distribution, when the abscissa axis is set as the detection time, the photon detection probability can be expressed with a graph illustrated in FIG. 4A. In this case, a solid line denotes high illumination, a dashed line denotes intermediate illumination, and a single-dot chain line denotes low illumination. An interval-wise cumulative detection probability is expressed as F (t, λ)=1−e^{-λt}, and can be expressed with a graph illustrated in FIG. 4B. Moreover, an interval-wise cumulative detection probability obtained by accumulating detection probabilities for respective detection intervals (0 to 1, 1 to 2, and so on) can be expressed as F′ (n, λ)=F (tₙ, λ)+F (tₙ+1, λ), and can be expressed with a graph illustrated in FIG. 4C.

By performing such a calculation, a photon detection probability can be determined for every detection interval. This interval-wise cumulative detection probability and the total sum (expectation value E) of the products of the detection times corresponding thereto can be determined based on the following expression:

$$E ( λ ) = {\sum }_{i = 0}^{n} {t}_{i} \cdot {F}^{′} ( i , λ )$$

This expectation value E corresponds to Tₐᵥₑ illustrated in FIG. 3B. Based on the above calculation, the number Nₚₕ of incident photons can be estimated from the expectation value E even when the detection time is discrete.

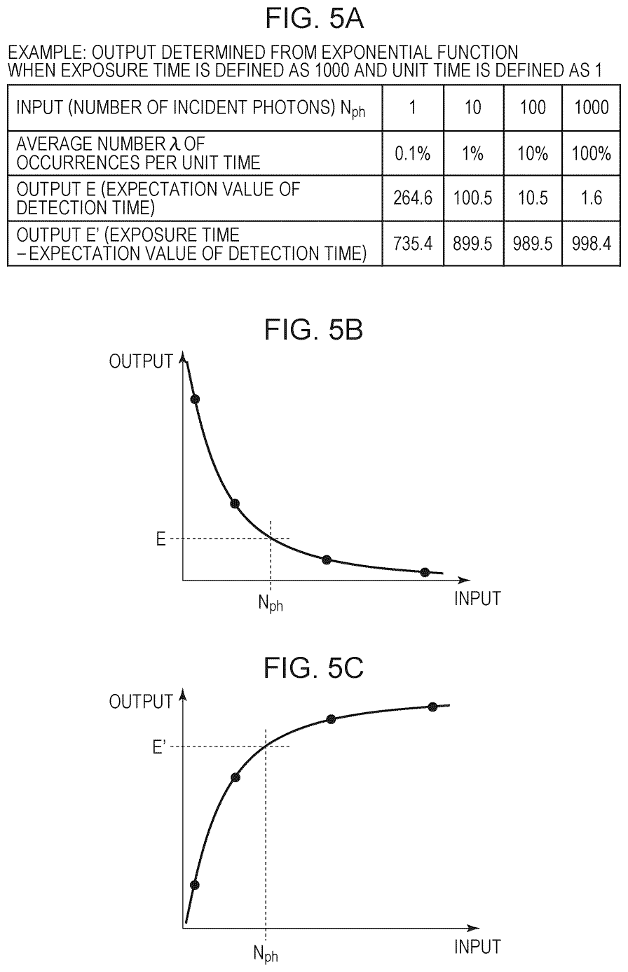

FIG. 5A illustrates a specific example of the expectation value relative to the number of incident photons. Assuming that the exposure period is defined as 1000 and the unit time is defined as 1, FIG. 5A indicates an output E (i.e., expectation value of detection time) obtained when an input (i.e., number of incident photons) changes to 1, 10, 100, and 1000, as well as an output E′ (exposure time-expectation value of detection time).

FIG. 5B and FIG. 5C illustrate graphs of input-output characteristics relative to the output E and the output E′, respectively. The output E forms a curve in which the output E decreases with increasing number Nₚₕ of incident photons. In contrast, the output E′ forms a curve in which the output E′ increases with increasing number Nₚₕ of incident photons.

An imaging device normally outputs a signal whose output increases with increasing number of incident photons as an input. Therefore, in view of signal processing to be performed in a later stage, the output E′ may be output in place of the output E.

According to this configuration, the number of incident photons within an exposure period can be estimated from a photon detection timing, so that the dynamic range can be expanded relative to the number of photons detected. Moreover, since the duration of a sub-frame period can be set by a photon exposure controller, an adjustment can be performed to prevent a counter from becoming saturated during one frame period. Thus, the counter can be prevented from stopping during one frame period while the dynamic range is ensured, thereby preventing signal information from being missing.

By utilizing the technical concept described above, a configuration that stops the counter during one frame period may be additionally employed.

Each of the embodiments will be described below.

### First Embodiment

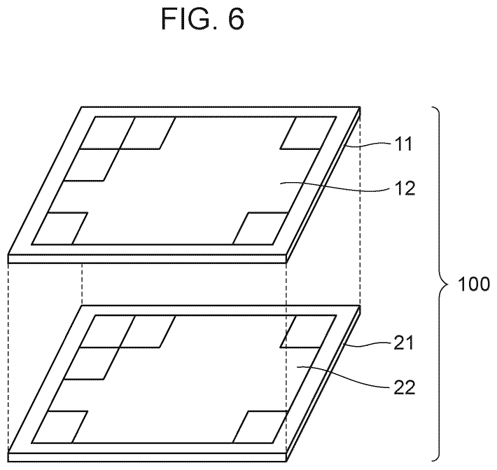

FIG. 6 illustrates the configuration of the photoelectric conversion device 100 of a multilayered type according to this embodiment. The photoelectric conversion device 100 is formed by stacking two substrates, namely, a first substrate 11 (sensor substrate) and a second substrate 21 (circuit substrate), and electrically connecting the two substrates to each other. The first substrate 11 includes multiple photoelectric conversion elements 1. The circuit substrate includes a circuit of a signal processor 103. Each of the first substrate 11 and the second substrate 21 is described as being a diced chip below, but is not limited to a chip. For example, each substrate may be a wafer. Alternatively, the substrates may be diced after being stacked in a wafer state, or may be formed into chips that are subsequently stacked and joined to each other.

The first substrate 11 has a pixel region 12. The second substrate 21 has a circuit region 22 that processes a signal detected in the pixel region 12.

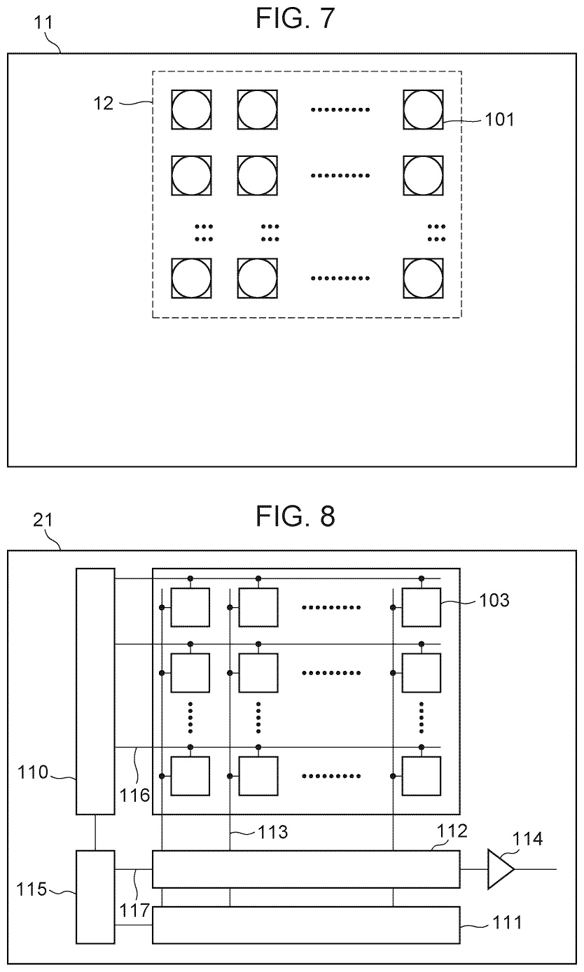

FIG. 7 illustrates a layout example of the first substrate 11. Pixels 101, each having a photoelectric conversion element 1 including an avalanche photodiode (APD), are arranged in a two-dimensional array in plan view, and form the pixel region 12.

FIG. 8 illustrates the configuration of the second substrate 21. The second substrate 21 includes signal processors 103 that process electric charges that have undergone photoelectric conversion at the photoelectric conversion elements 1, a row circuit 112, a control pulse generator 115, a horizontal scan circuit unit 111, a signal line 113, a vertical scan circuit unit 110, a control line 116, and a control line 117.

The pixels 101 having the photoelectric conversion elements 1 in FIG. 7 and the signal processors 103 in FIG. 8 are electrically connected via connection wires provided for the respective pixels. Each pixel 101 and the corresponding signal processor 103 may sometimes be referred to as a pixel circuit.

The vertical scan circuit unit 110 in FIG. 8 receives a control pulse supplied from the control pulse generator 115, and supplies the control pulse to each pixel. The vertical scan circuit unit 110 used is a logic circuit, such as a shift register or an address decoder. A signal output from each photoelectric conversion element 1 is processed by the corresponding signal processor 103.

Each signal processor 103 is provided with, for example, a counter and a memory, and the memory retains a digital value therein.

The horizontal scan circuit unit 111 inputs a control pulse for sequentially selecting each row to the corresponding signal processor 103 so as to read a signal from the memory of each pixel retaining a digital signal.

With regard to a selected row, a signal is output to the signal line 113 from the signal processor 103 of the pixel selected by the vertical scan circuit unit 110.

The signal output to the signal line 113 is output to an external recording unit or signal processor of the photoelectric conversion device 100 via an output circuit 114.

In FIG. 7, the photoelectric conversion elements 1 in the pixel region 12 may be arranged one-dimensionally. This embodiment can achieve its advantages even if there is one pixel, and includes a case where there is one pixel. The function of each signal processor does not necessarily have to be provided for every one of the photoelectric conversion elements. For example, a single signal processor may be shared among multiple photoelectric conversion elements, and may perform signal processing in a sequential manner.

As illustrated in FIG. 7 and FIG. 8, multiple signal processors 103 are disposed in a region overlapping the pixel region 12 in plan view. In plan view, the vertical scan circuit unit 110, the horizontal scan circuit unit 111, the row circuit 112, the output circuit 114, and the control pulse generator 115 are disposed in a region overlapping a region between the edges of the first substrate 11 and the edges of the pixel region 12. In other words, the first substrate 11 has the pixel region 12 and a non-pixel region disposed around the pixel region 12. The vertical scan circuit unit 110, the horizontal scan circuit unit 111, the row circuit 112, the output circuit 114, and the control pulse generator 115 are disposed in a region overlapping the non-pixel region in plan view.

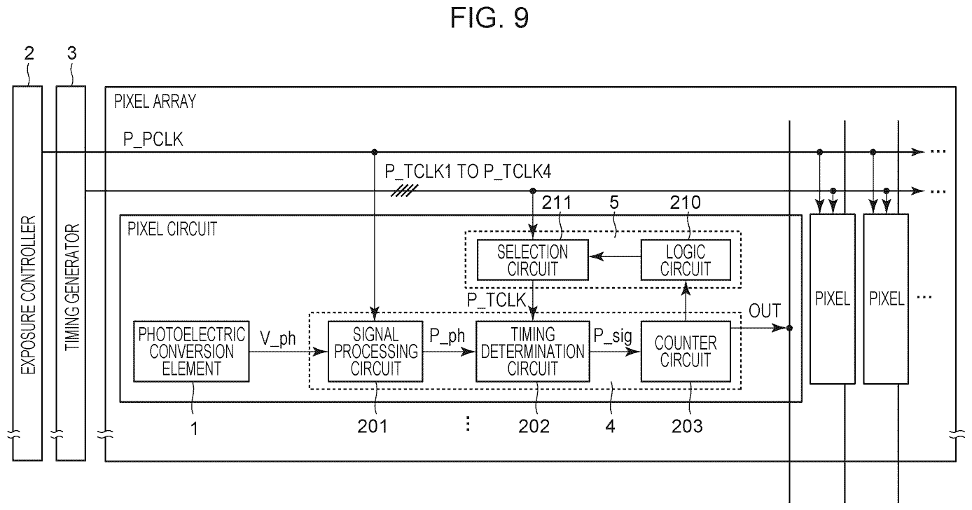

FIG. 9 illustrates an example of a block configuration of a pixel array, the timing generator 3, and the measurer 4. The exposure controller 2 and the timing generator 3 may be included in the vertical scan circuit unit 110 or the control pulse generator 115 illustrated in FIG. 8. A pixel circuit includes the photoelectric conversion element 1, the measurer 4, and the pulse controller 5.

The measurer 4 is constituted of a signal processing circuit 201, a timing determination circuit 202, and a counter circuit 203. For example, the signal processing circuit 201 is a waveform shaping circuit, or is a resistor or switch provided between a voltage to be applied to the photoelectric conversion element and the photoelectric conversion element. Each signal processor 103 illustrated in FIG. 8 corresponds to the measurer 4 illustrated in FIG. 9 (i.e., the signal processing circuit 201, the timing determination circuit 202, and the counter circuit 203).

The pulse controller 5 is constituted of a logic circuit 210 and a selection circuit 211. The logic circuit 210 compares a value output from the counter circuit 203 with an output from the logic circuit 210, and outputs a comparison result to the selection circuit 211. The selection circuit 211 receives multiple pulse signals P_TCLK1, P_TCLK2, and P_TCLK3 from the timing generator 3, and selects which of the pulse signals is to be input to the timing determination circuit 202 based on the comparison result from the selection circuit 211.

A pulse signal P_PCLK is output from the exposure controller 2 and is input to the signal processing circuit 201. The pulse signals P_TCLK1, P_TCLK2, and P_TCLK3 are output from the timing generator 3, and a pulse signal selected via the selection circuit 211 is input to the timing determination circuit 202.

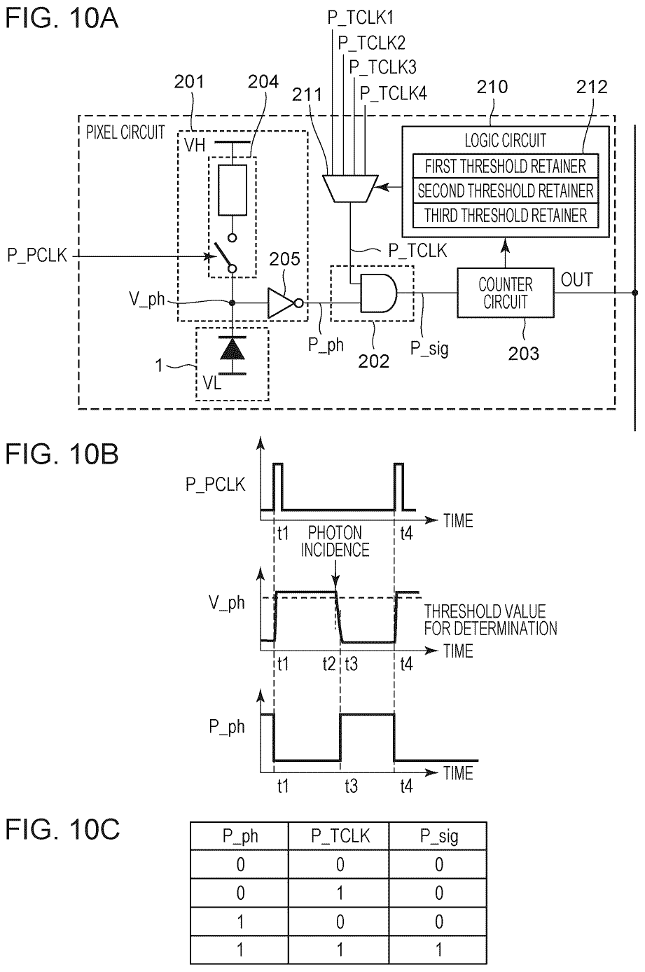

FIG. 10A illustrates an example of the pixel circuit configuration. The photoelectric conversion element 1 is a single photon avalanche photodiode (SPAD), and generates an electric charge pair according to incident light by photoelectric conversion. The anode of the photoelectric conversion element 1 is supplied with a voltage VL (first voltage). The cathode of the photoelectric conversion element 1 is supplied with a voltage VH (second voltage) that is higher than the voltage VL supplied to the anode. The anode and the cathode are supplied with a reverse bias voltage (i.e., a voltage higher than or equal to the breakdown voltage) to cause the photoelectric conversion element 1 to perform avalanche multiplication operation. By supplying such a voltage, an electric charge occurring due to incident light induces avalanche multiplication, whereby an avalanche current occurs.

The case where a reverse bias voltage is supplied includes the Geiger mode in which the potential difference between the anode and the cathode is greater than the breakdown voltage and the linear mode in which the potential difference between the anode and the cathode is near the breakdown voltage or smaller than or equal to the breakdown voltage. An APD operating in the Geiger mode is referred to as an SPAD. For example, the voltage VL (first voltage) is −30 V, and the voltage VH (second voltage) is 1 V. The APD may operate in the linear mode or in the Geiger mode.

The signal processing circuit 201 includes a quenching element 204 and a waveform shaping circuit 205. The quenching element 204 is connected to a power supply that supplies the voltage VH and to the photoelectric conversion element 1. The quenching element 204 functions as a load circuit (quenching circuit) during signal multiplication based on avalanche multiplication, and has the role of suppressing avalanche multiplication by reducing the voltage to be supplied to the photoelectric conversion element 1 (quenching operation). Moreover, the quenching element 204 has the role of returning the voltage to be supplied to the photoelectric conversion element 1 to the voltage VH by causing an electric current to flow by an amount equivalent to the amount of voltage dropped in the quenching operation (recharging operation). For example, the quenching element 204 may be constituted of a p-channel metal-oxide semiconductor (PMOS) transistor or an n-channel metal-oxide semiconductor (NMOS) transistor. FIG. 10A illustrates an example where an electrical connection is switchable by disposing a switch, such as a transistor, between the power supply and the photoelectric conversion element 1. A resistor of the quenching element 204 may be a wire resistor, or the resistor may be omitted from the equivalent circuit diagram.

The waveform shaping circuit 205 shapes a potential change obtained at the time of photon detection at the cathode of the photoelectric conversion element 1, and outputs a pulse signal. The waveform shaping circuit 205 used is, for example, an inverter circuit. Although the example illustrated in FIG. 10A uses a single inverter as the waveform shaping circuit 205, a circuit having multiple series-connected inverters may be used, or another circuit having a waveform shaping effect may be used.

The timing determination circuit 202 is connected to the waveform shaping circuit 205 and the counter circuit 203. The timing determination circuit 202 receives a signal output from the waveform shaping circuit 205 and a pulse signal P_TCLK output from the selection circuit 211, and outputs a signal to the counter circuit 203 in accordance with a combination of these signals. One example is an AND circuit.

The logic circuit 210 includes, for example, multiple threshold retainers. A threshold value can be set to a predetermined value. The multiple threshold retainers retain different values as reference threshold values. The logic circuit 210 compares a value output from the counter circuit 203 with the threshold value retained in each of the multiple threshold retainers, and outputs a comparison result to the selection circuit 211. In FIG. 9 and FIGS. 10A to 10C, three pulse signals P_TCLK1, P_TCLK2, and P_TCLK3 are input to the selection circuit 211, but the number of pulse signals input to the selection circuit 211 may be four or more so long as the number of pulse signals is at least two.

FIG. 10B illustrates the relationship among the pulse signal P_PCLK, V_ph (i.e., a cathode potential of the photoelectric conversion element 1), and P_ph (i.e., an output from the waveform shaping circuit 205) in clocked recharge driving. At a time point t1, the pulse signal P_PCLK transitions from low (L) level to high (H) level. When the switch is turned on, the cathode terminal of the photoelectric conversion element 1 is electrically connected to the power-supply voltage, and a reverse bias is applied to the photoelectric conversion element 1. Specifically, a state where the pulse signal P_PCLK is at H level and the switch is in the on mode is a charging mode. Since the charging mode is repeated multiple times, this state is also referred to as a recharging mode. When the reverse bias is applied, the cathode potential V_ph increases. When the cathode potential V_ph exceeds a threshold value for determination, the output P_ph transitions from H level to L level. Subsequently, the pulse signal P_PCLK transitions from H level to L level, and the photoelectric conversion element 1 enters a standby mode to wait for photon incidence. When a photon is incident at a time point t2, the cathode potential V_ph decreases. When the cathode potential V_ph surpasses the threshold value for determination at a time point t3, the output P_ph transitions from L level to H level. Subsequently, the pulse signal P_PCLK transitions from L level to H level again at a time point t4, the switch is turned on, and the above-described operation is repeated.

According to this clocked recharge driving, even if a large number of photons become incident in the standby mode, at least one output signal can be counted, so that this driving is effective as a countermeasure against pile-up.

FIG. 10C illustrates a truth table indicating an output P_sig with respect to an input P_ph and a pulse signal P_TCLK to the timing determination circuit 202. 0 indicates L level, and 1 indicates H level. In one embodiment, since the timing determination circuit 202 is constituted of an AND circuit, the output P_sig is at H level only when the input P_ph and the pulse signal P_TCLK are at H level.

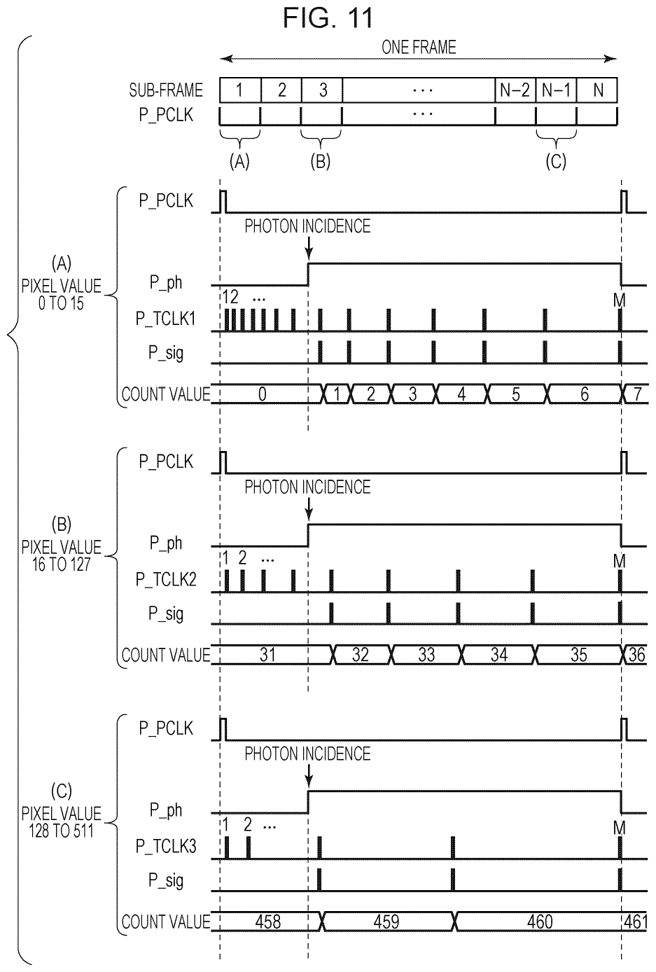

FIG. 11 illustrates a drive timing chart for explaining the exposure period and the pulse signals. One frame period is constituted of N sub-frames. The start and end of each sub-frame are defined by the pulse signal P_PCLK. One sub-frame contains pulses selected from the pulse signals P_TCLK1 to P_TCLK3. The pulse signal P_TCLK1 includes M pulses within one sub-frame, the pulse signal P_TCLK2 includes N pulses within one sub-frame, and the pulse signal P_TCLK3 includes O pulses within one sub-frame. In this case, the number of pulses satisfies the relationship M>N>O. The pulses are input to the timing determination circuit 202. In FIG. 11, the pulses of each pulse signal P_TCLK are spaced at nonuniform intervals, with the intervals being proportional to an approximate logarithm. As will be described later, the pulses of each pulse signal P_TCLK may be spaced at uniform intervals. Alternatively, the pulses may be spaced at nonuniform intervals that are proportional to an approximate reciprocal.

FIG. 11 is a diagram embodying the concept of FIGS. 3A to 3C described above. A pulse of the pulse signal P_PCLK serves as a starting point of a sub-frame, and an interval of the sub-frame is T_{acc}. The output P_ph transitions from L level to H level when a photon is incident, and transitions from H level to L level in accordance with the recharging operation of the photoelectric conversion element 1 when a pulse of the pulse signal P_PCLK is input. A pulse signal P_TCLK is for defining time information within a sub-frame.

In accordance with the configuration of the timing determination circuit 202 described in FIGS. 10A to 10C, the number of pulse signals P_TCLK at or after the first photon detection within a sub-frame is a count value. The timing determination circuit 202 outputs a pulse signal at or after a first photon detection timing within a sub-frame period.

In FIG. 11, a signal P_sig is input to a counter in a first sub-frame (A), and a value of six is counted by the counter. Accordingly, when a photon is incident toward the beginning of a sub-frame, the count value of the counter is large, whereas when a photon is incident toward the end of a sub-frame, the count value of the counter is small. In other words, a numerical value corresponding to the time from when a sub-frame begins to when a photon is first detected can be measured based on a pulse signal P_TCLK.

By adding count values by repeating this count N times, a count value corresponding to an expectation value E′ of the detection time can be obtained. Accordingly, as described above, the number of incident photons can be estimated from the expectation value E′.

According to this configuration, the number of incident photons within the exposure period can be estimated from the photon detection timing, so that the dynamic range can be expanded relative to the number of detected photons. Moreover, since the duration of a sub-frame period can be set by a photon exposure controller, an adjustment can be performed to prevent a counter from becoming saturated during one frame period. Thus, the counter can be prevented from stopping during one frame period while the dynamic range is ensured, thereby preventing signal information from being missing.

In clocked recharge driving in the related art where the timing determination circuit 202 is not provided, the number of sub-frame periods is the maximum number that can be counted in one frame period. For example, if the number of sub-frames is N, the maximum count value is N, such that a maximum of N photons can be detected. The dynamic range (defined as a maximum output value) is N. Basically, since power consumption is proportional to the number of detections, if the number of detections is to be reduced to achieve low power consumption, the dynamic range decreases. In contrast, increasing the dynamic range leads to higher power consumption. In other words, there is a trade-off relationship between the dynamic range and the power consumption.

On the other hand, in the photoelectric conversion device 100 according to this embodiment that is provided with the timing determination circuit 202, the estimated number of photons corresponds to the dynamic range. Although power consumption is proportional to the number of detections, as in the related art, since the estimated number of photons is not dependent on the number of photons detected, the trade-off relationship between the dynamic range and the power consumption can be eliminated.

Furthermore, in this embodiment, since the number of pulses of the pulse signal P_TCLK can be changed in accordance with the count value, the dynamic range can be further expanded without increasing the number of bits.

For example, in FIG. 10A, the threshold values of a first threshold retainer, a second threshold retainer, and a third threshold retainer are set to “14”, “126”, and “510”, respectively. In the first sub-frame, the selection circuit 211 selects the pulse signal P_TCLK1, and inputs the pulse signal P_TCLK1 as a pulse signal P_TCLK to the timing determination circuit 202.

If a pixel value output from the counter circuit 203 in a previous sub-frame within one frame is any of 0 to 14 serving as a predetermined value, the pulse signal P_TCLK1 is input as a pulse signal P_TCLK to the timing determination circuit 202 in a subsequent sub-frame.

If the pixel value output from the counter circuit 203 in the previous sub-frame within one frame is any of 15 to 126 serving as a predetermined value larger than 14, the pulse signal P_TCLK2 is input as a pulse signal P_TCLK to the timing determination circuit 202 in the subsequent sub-frame. The pulse signal P_TCLK2 has a smaller number of pulses per sub-frame than the pulse signal P_TCLK1.

If the pixel value output from the counter circuit 203 in the previous sub-frame within one frame is any of 127 to 510, the pulse signal P_TCLK3 is input as a pulse signal P_TCLK to the timing determination circuit 202 in the subsequent sub-frame. The pulse signal P_TCLK3 has a smaller number of pulses per sub-frame than the pulse signal P_TCLK2.

If the pixel value output from the counter circuit 203 in the previous sub-frame within one frame is larger than 511, a pulse signal P_TCLK4 is input as a pulse signal P_TCLK to the timing determination circuit 202 in the subsequent sub-frame. The pulse signal P_TCLK4 has a smaller number of pulses per sub-frame than the pulse signal P_TCLK3.

According to this configuration, the dynamic range can be expanded without increasing the number of bits in the counter circuit 203 included in the measurer 4. The following description relates to an imaging scene where, within one frame period, high brightness is achieved only during a short period and low brightness is maintained during other periods. In a sub-frame corresponding to high brightness, the count value is smaller than the actual number of incident photons. In a sub-frame corresponding to low brightness, the count value is close to the actual number of incident photons. Since correction processing by a linear corrector is performed assuming that the number of incident photons is uniform in one frame period, the effect of a photon count loss in the sub-frame corresponding to high-brightness is large, and the corrected pixel value becomes lower than the brightness perceived by the human eye. In order to reduce this issue, the count value in each sub-frame is increased in a period in which the pixel value within one frame is low, so that a sufficient count value can be obtained even in a high brightness scene only during a short period within one frame period.

Although the pulse signal P_TCLK1 is input as a pulse signal P_TCLK to the timing determination circuit 202 in the first sub-frame within one frame in FIG. 11, the configuration is not limited to this. For example, the pulse signal P_TCLK2 may be input as a pulse signal P_TCLK to the timing determination circuit 202 in the first sub-frame within one frame. In this case, if the pixel value output from the counter circuit 203 is smaller than 15 serving as a predetermined value (i.e., smaller than or equal to 14), the pulse signal P_TCLK1 may be input as a pulse signal P_TCLK to the timing determination circuit 202 in the subsequent sub-frame. P_TCLK with Uniform Intervals and P_TCLK with Nonuniform Intervals

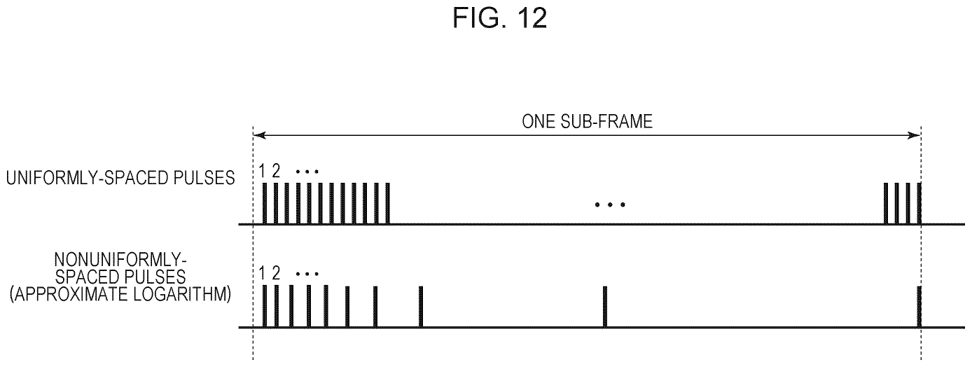

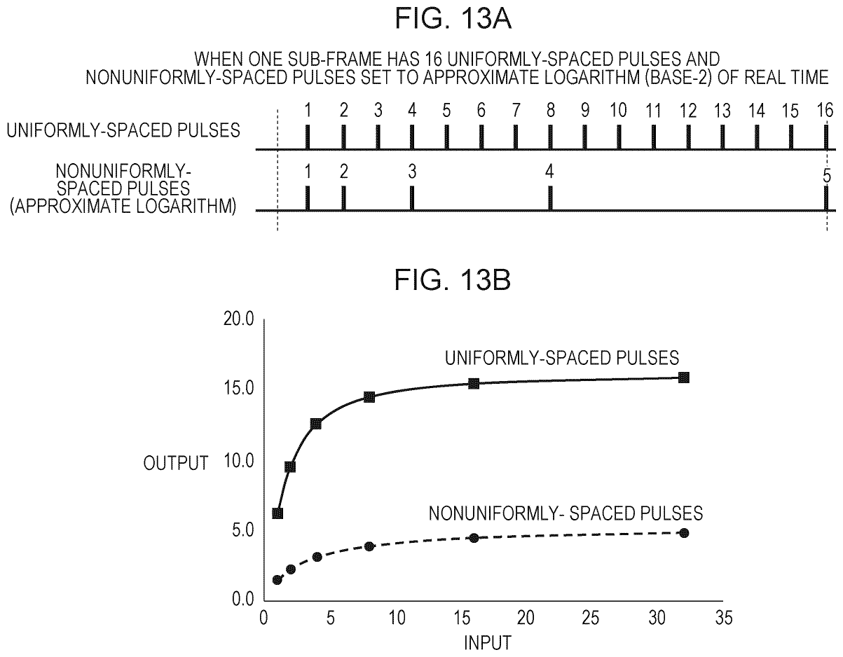

FIG. 12 is a schematic comparison diagram between a pulse signal P_TCLK with uniform intervals and a pulse signal P_TCLK with nonuniform intervals. The upper part of FIG. 13A illustrates an example where one sub-frame has 16 uniformly-spaced pulses. Uniformly-spaced pulses correspond to real time. The lower part illustrates an example where nonuniformly-spaced pulses are set to an approximate logarithm (base-λ) of real time. The reason for inserting “approximate” here is as follows. While the logarithm of 1 is 0 when 2 is set as the base, and the logarithm of 2 is 1 when 2 is set as the base, the nonuniformly-spaced pulses are set to 1 and 2, respectively, by adding 1 thereto to compare them with the uniformly-spaced pulses in FIG. 13A. The intervals of these nonuniformly-spaced pulses are expressed as being set such that the pulse space corresponds to a logarithmic compression of the real space. The intervals of a nonuniformly-spaced pulse signal can be configured such that the period increases in accordance with the elapsed time in a sub-frame.

FIG. 13B is a graph illustrating the relationship between the count value (output) and the number of incident photons (input) with respect to uniformly-spaced pulses. As illustrated in FIG. 13B, when a comparison is performed based on the same number of incident photons (input), the output of nonuniformly-spaced pulses is smaller than the output of uniformly-spaced pulses. In other words, nonuniformly-spaced pulses enable determination of the same number of incident photons based on a smaller count value. Thus, nonuniformly-spaced pulses enable a smaller-scale counter circuit, whereby the pixel circuit can be reduced in area. On the other hand, with uniformly-spaced pulses, an average interval between pulses can be reduced, so that the signal-to-noise (S/N) ratio becomes relatively higher, as compared with nonuniformly-spaced pulses.

### Second Embodiment

This embodiment relates to a configuration example provided with a pixel circuit different from that in the first embodiment. Since components other than those to be described below are substantially similar to the components in the first embodiment, descriptions thereof will be omitted.

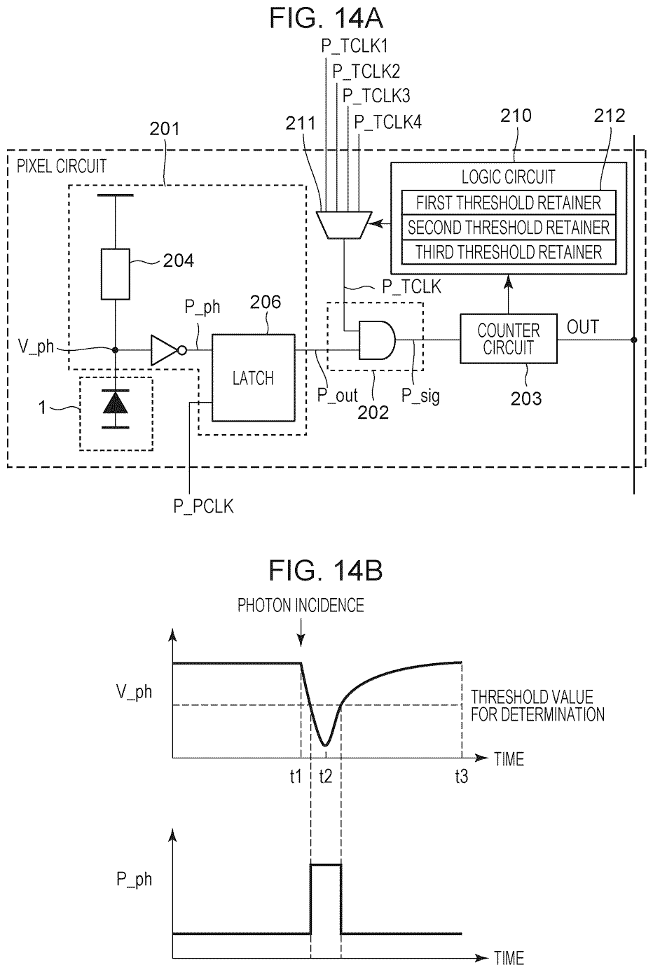

A pixel circuit according to this embodiment illustrated in FIG. 14A is different from the pixel circuit illustrated in FIG. 10A in that the switch that receives the pulse signal P_PCLK and that is provided between the power-supply voltage and the photoelectric conversion element 1 is omitted, and that a latching circuit 206 is added to the signal processing circuit 201. The pulse signal P_PCLK is input to the latching circuit 206. Even in the example illustrated in FIG. 14A, the quenching element 204 used may be an element functioning as a resistor. Therefore, the quenching element 204 used may be not only a metallic resistor but also, for example, a transistor.

FIG. 14B illustrates a change in the cathode potential V_ph of the photoelectric conversion element 1 illustrated in FIG. 14A. The difference from FIG. 10B is that the voltage autonomously returns to an initial state after the cathode potential drops due to photon incidence. This pixel operation is called a passive operation.

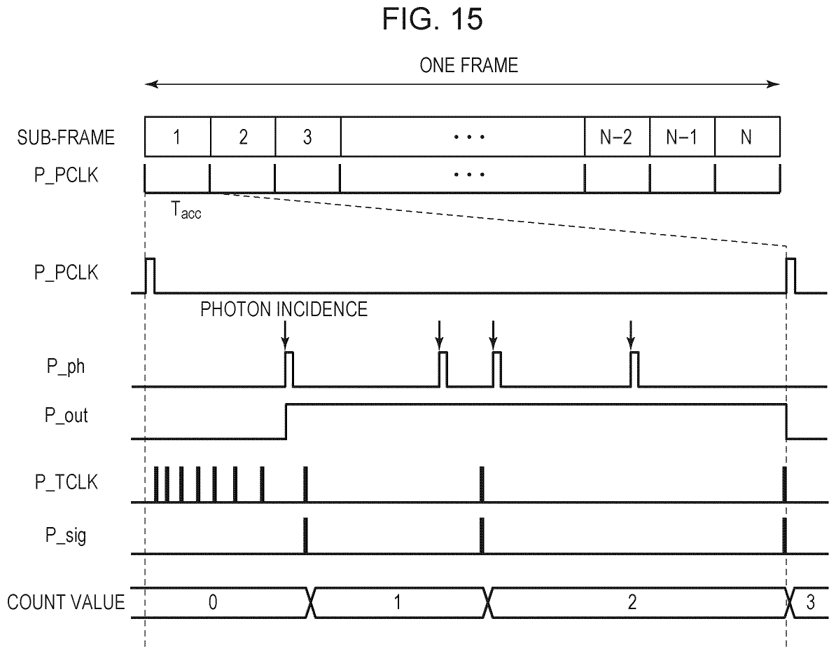

FIG. 15 illustrates a drive timing chart according to this embodiment. In FIG. 15, one of the pulse signals P_TCLK1 to P_TCLK3 is indicated as P_TCLK. The difference from FIG. 11 is that the output P_ph repeatedly transitions between high and low multiple times in accordance with photon incidence in one sub-frame. However, since an output P_out output from the latching circuit 206 and input to the timing determination circuit 202 matches the output P_ph in FIG. 11, the output P_sig that is ultimately output is the same. Even in such a passive-drive ADP element, advantages similar to those in the first embodiment can be achieved.

Specifically, according to this configuration, the number of incident photons within the exposure period can be estimated from the photon detection timing, so that the dynamic range can be expanded relative to the number of photons detected. Moreover, since the duration of a sub-frame period can be set by a photon exposure controller, an adjustment can be performed to prevent a counter from becoming saturated during one frame period. Thus, the counter can be prevented from stopping during one frame period while the dynamic range is ensured, thereby preventing signal information from being missing.

Furthermore, in this configuration, since the estimated number of photons corresponding to the dynamic range is not dependent on the detected number of photons corresponding to the power consumption, the trade-off relationship between the dynamic range and the power consumption can be eliminated.

### Third Embodiment

This embodiment relates to a configuration example provided with a pixel circuit different from those in the above embodiments.

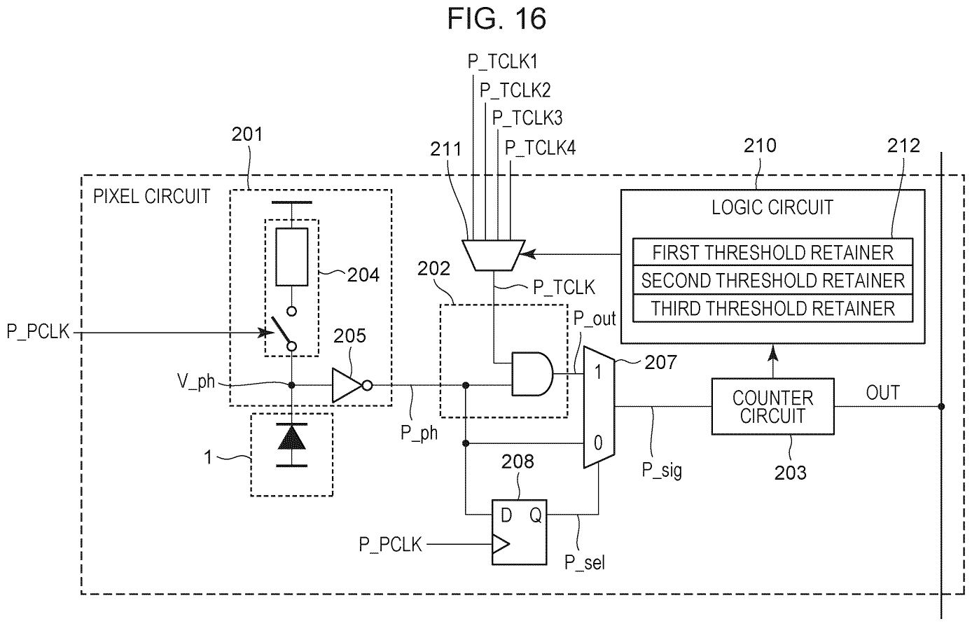

The pixel circuit according to this embodiment illustrated in FIG. 16 is different from the pixel circuit illustrated in FIG. 10A in being additionally provided with a signal selection circuit 207 and a signal retention circuit 208. With the addition of these circuits, a signal to be input to the counter circuit in an M-th sub-frame can be switched to P_out or P_ph by referring to information indicating whether or not photon incidence has occurred in an (M-1)-th sub-frame. Because an output in a subsequent sub-frame is changed in accordance with the result in a previous sub-frame, this circuit will be referred to as “time correlation filter”.

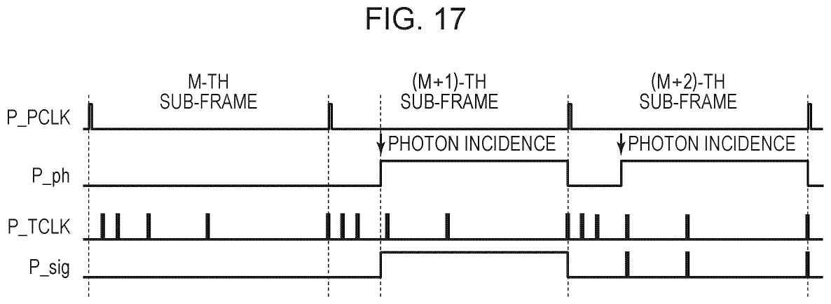

FIG. 17 illustrates an operation sequence according to this embodiment. Since there is no photon incidence in the M-th sub-frame, the output P_ph is at L level. This L-level information is retained in the signal retention circuit 208.

Subsequently, when P_PCLK defining the start of an (M+1)-th sub-frame transitions from L level to H level, an L-level signal is output from the signal retention circuit 208, and the L-level signal is input to the signal selection circuit 207. Accordingly, the signal selection circuit 207 is configured to output P_ph as P_sig without outputting P_out as P_sig. When photon incidence occurs in the (M+1)-th sub-frame, P_ph transitions from L level to H level, so that P_sig also transitions from L level to H level. Moreover, since P_ph transitions from L level to H level, H-level information is retained in the signal retention circuit 208.

Subsequently, when P_PCLK defining the start of an (M+2)-th sub-frame transitions from L level to H level, P_ph transitions from H level to L level, and P_sig transitions from H level to L level. The level transition of P_PCLK causes an H-level signal to be output from the signal retention circuit 208, and the signal selection circuit 207 outputs P_out as P_sig. In other words, the signal selection circuit 207 is configured to be capable of outputting a signal corresponding to a pulse signal defining time information within the (M+2)-th sub-frame period. When photon incidence occurs in the (M+2)-th sub-frame, P_ph transitions from L level to H level, so that P_out is output as P_sig.

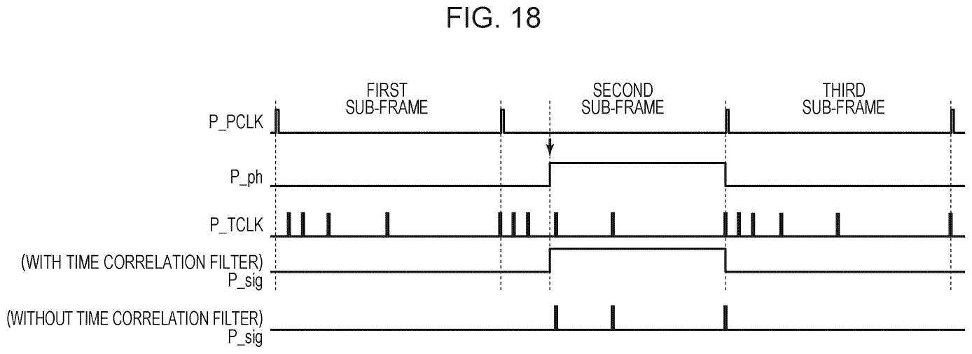

FIG. 18 illustrates an operation sequence for explaining the effect of the time correlation filter. The time correlation filter exhibits an effect when a signal of about one count or less is treated in one sub-frame. This is because, as the photon incidence frequency decreases, the photon incidence probability becomes constant regardless of time based on an exponential distribution function. In other words, the probability of incidence in each time window becomes substantially the same.

In FIG. 18, one photon is incident in a second sub-frame. Accordingly, when photon incidence occurs at the timing illustrated in FIG. 18, P_sig is counted as one when there is a time correlation filter, and P_sig is counted as three when there is no time correlation filter.

When a signal of about one count or less is treated in one sub-frame in this manner, the configuration without a time correlation filter results in a larger number of incident photons counted than the true number of incident photons, thus resulting in an error in a low illumination region. In other words, this may cause an increase in noise. In contrast, in this embodiment, when a signal of about one count or less is treated in one sub-frame, the signal is counted only as one unless the signal is detected continuously, so that an error can be suppressed, thus reducing the noise increasing factor. Consequently, the S/N ratio can be improved in a low output region. Moreover, since the dark count rate (DCR) in the dark state also corresponds to a signal of about one count or less in one sub-frame, the use of this time correlation filter enables the aforementioned reduction based on the same theory.

As an alternative to the above-described circuit example that involves outputting one count unless the signal is detected continuously, the circuit may output a predetermined value, where the predetermined value is a value larger than or equal to one count.

### Fourth Embodiment

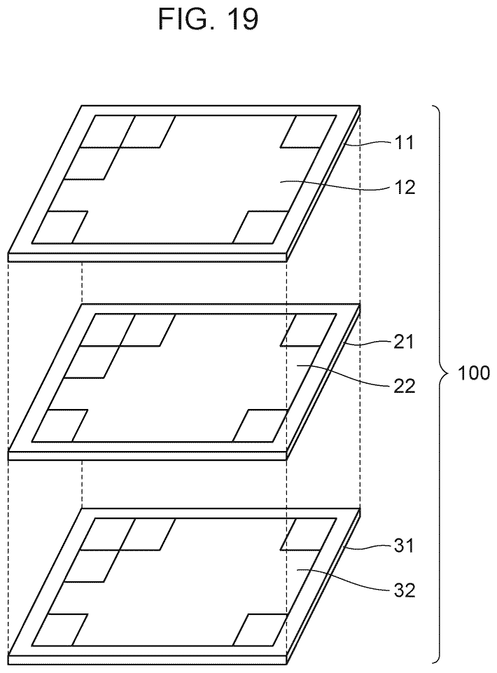

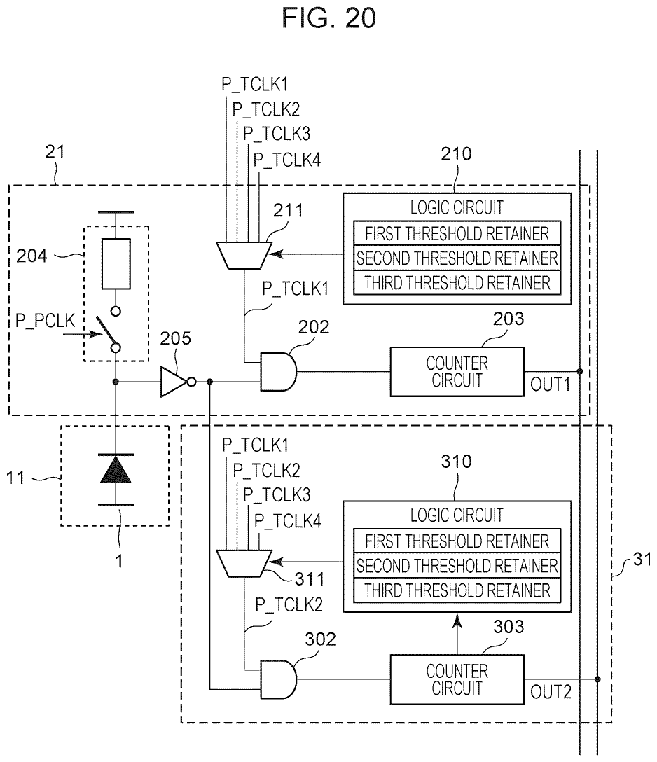

A fourth embodiment will now be described with reference to FIG. 19 and FIG. 20. This embodiment is different in having three layers.

In FIG. 19, a third substrate 31 (third substrate) and a second circuit region 32 are added.

FIG. 20 schematically illustrates the layout of a three-layered pixel circuit. As compared with the pixel circuit in FIG. 10A, a second timing determination circuit 302, a second counter circuit 303, and a second logic circuit 310 and a second selection circuit 311 serving as a second pulse controller are added, and these circuits are disposed in the third substrate 31.

The second timing determination circuit 302 is configured to receive a pulse signal selected by the second selection circuit 311 and an output from the waveform shaping circuit 205. In FIG. 20, it is assumed that the vertical scan circuit unit 110 and the control pulse generator 115 are provided in the second substrate 21, so that the pulse signals P_TCLK1 to P_TCLK4 are input to the third substrate 31 from the circuits provided in the second substrate 21. Due to not having the quenching element 204 and the waveform shaping circuit 205, the third substrate 31 can ensure space, as compared with the second substrate 21. Thus, the third substrate 31 may be provided with the vertical scan circuit unit 110 and the control pulse generator 115. In this case, the pulse signal P_PCLK and the pulse signals P_TCLK1 to P_TCLK4 may be input to the second substrate 21 from the third substrate 31.

In this embodiment, threshold values to be set in the first to third threshold retainers of the logic circuit 210 and threshold values to be set in the second logic circuit 310 may be varied. For example, the threshold values may be set to low values in the first to third threshold retainers of the logic circuit 210, and the threshold values in first to third threshold retainers of the second logic circuit 310 may be set to values higher than those in the threshold retainers of the logic circuit 210. When two counters have different numbers of bits, it becomes possible to effectively utilize the implemented bit width by respectively setting separate threshold values.

With the three-layer stacking structure in this embodiment, multiple circuits can be readily parallelized, so that enhanced functionality can be achieved. In detail, the timing determination circuits 202 and 302 can be provided in parallel, so that two outputs with different count values can be obtained from a single photon detection signal by using the pulse signals P_TCLK1 and P_TCLK2 having different signal waveforms. Depending on the number of pulses and the pulse intervals of the pulse signal P_TCLK, the merits and demerits of various characteristics (e.g., the dynamic range, S/N ratio, appropriate exposure amount, and power consumption) vary. With two outputs with different characteristics, an optimal output can be selected in accordance with the imaging scene, or the outputs may be combined to generate a higher quality image.

For example, when measurement is to be performed using one pulse signal P_TCLK as in the first embodiment, there is an assumed issue where a measurement error may increase in an imaging scene where the light quantity rapidly changes within one frame. This is due to the difference between the measured values at the photon detection timings of the respective sub-frames being large when average light becomes incident within one frame.

As one method for solving this issue, there is a solution involving concurrently acquiring a signal that enables an estimation of a change in the light quantity within one frame and performing correction. In detail, this can be achieved by, for example, in one embodiment, performing counting while limiting the pulse signal P_TCLK2 to the first single pulse, so as to count only incident photons at an early detection timing.

The threshold values in the first to third threshold retainers of the logic circuit 210 and the threshold values in the first to third threshold retainers of the second logic circuit 310 may be set to identical values.

### Fifth Embodiment

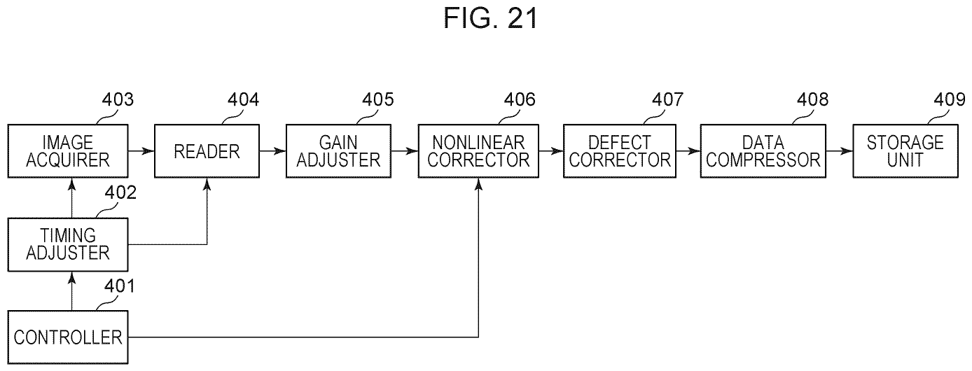

A photoelectric conversion system using the photoelectric conversion device according to any of the above embodiments will now be described with reference to FIG. 21. FIG. 21 is a block diagram schematically illustrating the configuration of the photoelectric conversion system according to this embodiment.

A processing device according to this embodiment includes a controller 401, a timing adjuster 402, an image acquirer 403, a reader 404, a gain adjuster 405, a nonlinear corrector 406, a defect corrector 407, a data compressor 408, and a storage unit 409.

The image acquirer 403 is, for example, a pixel circuit, and the reader 404 is provided, for example, downstream of the counter circuit 203. The controller 401 may be an internal controller of the photoelectric conversion device, or may be an external controller of the photoelectric conversion device. The image acquirer 403 is controlled by the timing adjuster 402 that is controlled by the controller 401. Image data generated by the image acquirer 403 is input to the storage unit 409 after undergoing correction processing. The order of the correction processing is not limited to the order illustrated in FIG. 21.

The gain adjuster 405 is provided between the reader 404 and the nonlinear corrector 406, and applies a digital gain to the image data generated by the image acquirer 403. Although image correction data often has a fractional value, if the output of the image is an integer, the correction accuracy may possibly decrease due to a quantization error. By applying a gain to the image data in advance, the effect of the quantization error can be suppressed, so that the correction accuracy can be enhanced. If the quantization error can be suppressed to one quarter or less of a one photon signal level, the corrected image becomes visually natural. Therefore, in one embodiment, the digital gain to be applied to the image data is, for example, four times or more.

The nonlinear corrector 406 is disposed between the gain adjuster 405 and the defect corrector 407 and corrects the image data by being controlled by the controller 401. If the image acquirer 403 is a photon-counting detector, the optical response often becomes nonlinear due to the effect of dead time. The effect of a nonlinear optical response may sometimes result in overcorrection when correction is performed on the assumption of a linear response. Therefore, by performing nonlinear correction on the image data before arithmetic processing at the defect corrector 407, overcorrection is prevented, whereby appropriate nonlinear correction according to the drive timing can be performed. This nonlinear correction is performed by using, for example, a look-up table.

The nonlinear corrector 406 includes a correction circuit that corrects a signal output from the image acquirer 403. The correction circuit changes a correction method in accordance with the pulse signal number selected by the selection circuit 211 in a pixel. For example, when the pulse signal P_TCLK2 is selected in a sub-frame, a pixel value is corrected such that the correction amount is larger than in a case where the pulse signal P_TCLK1 is selected. When the pulse signal P_TCLK1 is selected in a sub-frame, a pixel value is corrected such that the correction amount is smaller than in a case where the pulse signal P_TCLK2 is selected. Since the number of pulses input in a sub-frame decreases in the case of high illumination, the output may possibly become smaller than the original brightness under high illumination. According to this embodiment, correction is appropriately performed, so that the dynamic range can be expanded under high illumination.

The defect corrector 407 corrects defective pixel data included in the image data. As a specific example, the defect corrector 407 extracts an output value of a defective pixel, and identifies positional information and the output value of the defective pixel. Methods include a method involving replacing the output of pixels surrounding an identified defective pixel with an average value or a median value, and a method involving performing division by estimated defective image data.

The data compressor 408 compresses corrected image data. In the photoelectric conversion device according to the present disclosure, an enormous amount of image data corresponding to a high dynamic range is generated. By providing the data compressor 408, data can be compressed before being stored in the storage unit 409 located downstream.

The storage unit 409 stores at least a portion of the image data generated upstream. In detail, a memory, such as a static random access memory (SRAM), a dynamic random access memory (DRAM), or a nonvolatile memory, is used as the storage unit 409 for storing the image data.

Accordingly, this embodiment can achieve a photoelectric conversion system using the photoelectric conversion device according to any of above embodiments.

### Sixth Embodiment

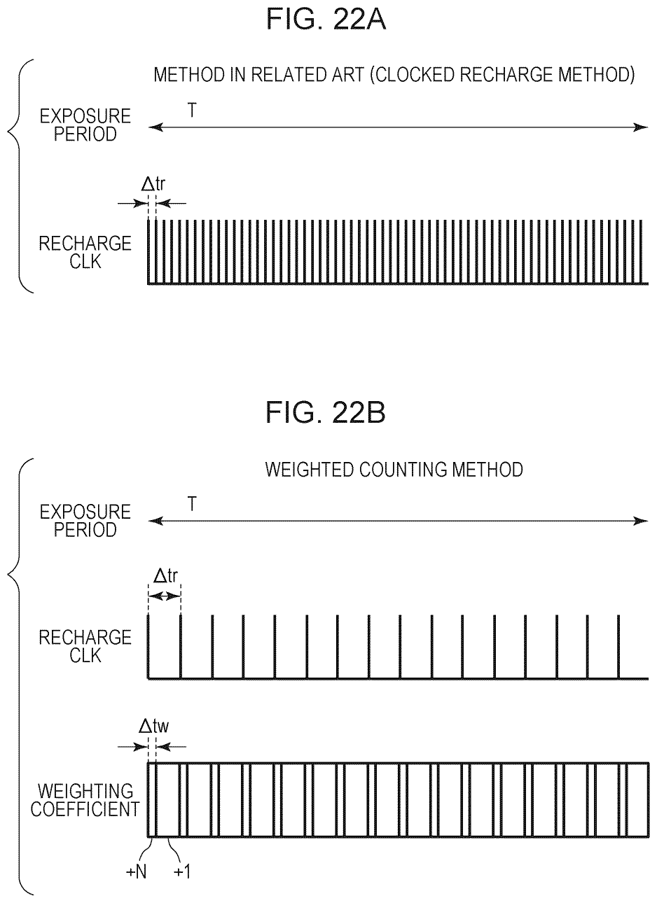

The advantages of the present disclosure will be further described with reference to FIGS. 22A and 22B. In the following description, the addition performed in each of the above embodiments will be referred to as “weighted counting method”.

In a clocked recharge method in the related art illustrated in FIG. 22A, a maximum estimated number of incident photons is determined by the number of recharge CLKs (P_PCLKs). Specifically, the dynamic range widens with increasing number of recharge CLKs. On the other hand, since power consumption increases proportionally to the number of recharge CLKs, there is a trade-off relationship between the dynamic range and the power consumption.

When an exposure period is defined as T and a pulse interval of recharge CLK is defined as Δtr, the number of recharge CLKs is expressed as T/Δtr, so that it can be regarded that the dynamic range is determined by T/Δtr.

In contrast, in the weighted counting method illustrated in FIG. 22B, the number of incident photons is estimated from the photon incident timing. Therefore, the maximum estimated number of incident photons is determined by T/Δtw. In this case, Δtw denotes a period from an input of a pulse of recharge CLK (P_PCLK in the embodiment) to an input of the first pulse of P_TCLK. Specifically, the maximum estimated number of incident photons is not dependent on the recharge CLK interval Δtr, and the dynamic range and the power consumption do not have a trade-off relationship. In this case, the weighting coefficient (an increment in count value corresponding to the incidence of one photon) is desirably set to Δtr/Δtw.

A specific numerical example will be indicated below. In the method in the related art, when the exposure period T is set to 1024 and Δtr is set to 1, the maximum number of avalanche occurrences is 1024, and in this case, the maximum number of incident photons detected is 1024. On the other hand, in the weighted counting method, when the exposure period T is set to 1024, Δtr is set to 4, and Δtw is set to 1, the maximum number of avalanche occurrences is 256. By performing addition to the counter circuit such that the count number corresponding to photons incident during Δtw becomes four, which is Δtr/Δtw, the maximum number of incident photons at this time is 1024. In other words, the power consumption associated with recharging can be suppressed to one quarter of that in the method in the related art, while a similar dynamic range can be achieved. In each of the above embodiments, addition of four at the timing of Δtw can be achieved by, for example, inputting four pulses of P_TCLK in a period sufficiently shorter than Δtw.

The weighting coefficient is desirably set to Δtr/Δtw because, under driving conditions where both methods have similar dynamic ranges, the saturation count number can be made to coincide. Setting such conditions enables reduction of false signals and the like during nonlinear correction. However, in one embodiment, since the power consumption is dependent only on Δtr but not on the weighting coefficient, the relational expression indicated above does not necessarily have to be satisfied from the standpoint of suppressing power consumption.

### Seventh Embodiment

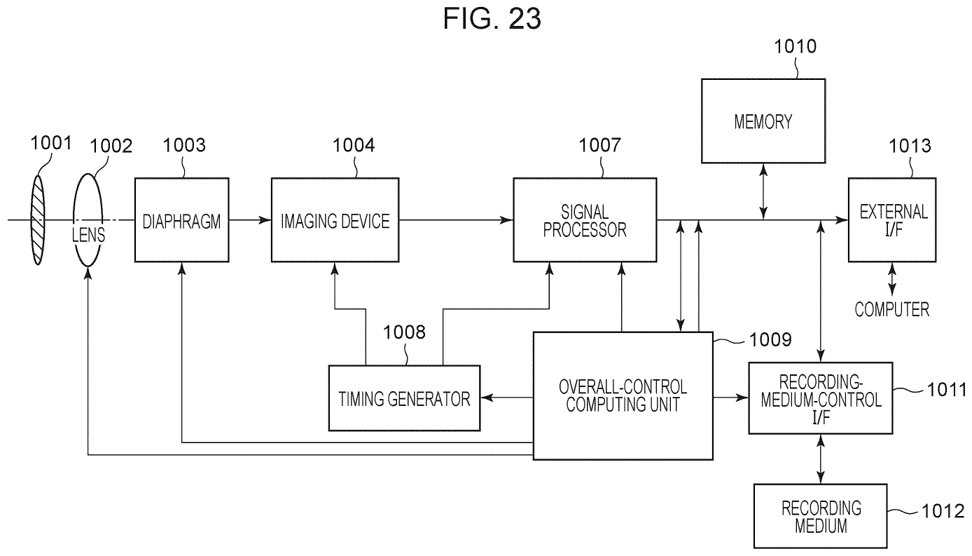

A photoelectric conversion system according to this embodiment will now be described with reference to FIG. 23. FIG. 23 is a block diagram schematically illustrating the configuration of the photoelectric conversion system according to this embodiment.

The photoelectric conversion device described in each of the above embodiments is applicable to various photoelectric conversion systems. Examples of applicable photoelectric conversion systems include a digital still camera, a digital camcorder, a monitoring camera, a photocopier, a facsimile apparatus, a mobile phone, an in-vehicle camera, and an observation satellite.

A camera module including an optical system, such as a lens, and an imaging device is also included in the photoelectric conversion system. The block diagram illustrated in FIG. 23 corresponds to a digital camera as one of the above examples.

The photoelectric conversion system illustrated in FIG. 23 includes an imaging device 1004 as an example of the photoelectric conversion device, and a lens 1002 that forms an optical image of a subject on the imaging device 1004. The photoelectric conversion system further includes a diaphragm 1003 for varying the amount of light transmitted through the lens 1002, and a barrier 1001 for protecting the lens 1002. The lens 1002 and the diaphragm 1003 constitute an optical system that focuses light onto the imaging device 1004. The imaging device 1004 is the photoelectric conversion device according to any of the above embodiments, and converts the optical image formed by the lens 1002 into an electrical signal.

The photoelectric conversion system includes a signal processor 1007 serving as an image generator that generates an image by processing an output signal output from the imaging device 1004. The signal processor 1007 performs various kinds of correction and compression, where necessary, and outputs image data. The signal processor 1007 may be provided in a semiconductor layer where the imaging device 1004 is provided, or may be provided in a semiconductor layer different from where the imaging device 1004 is provided. Alternatively, the imaging device 1004 and the signal processor 1007 may be provided in the same semiconductor layer.

The photoelectric conversion system further includes a memory 1010 for temporarily storing image data, and an external interface (external I/F) 1013 for communicating with, for example, an external computer. Moreover, the photoelectric conversion system includes a recording medium 1012, such as a semiconductor memory, for recording or reading imaging data, and a recording-medium-control interface (recording-medium-control I/F) 1011 for performing recording onto or reading from the recording medium 1012. The recording medium 1012 may be contained in the photoelectric conversion system or may be detachable therefrom.

The photoelectric conversion system further includes an overall-control computing unit 1009 that performs various kinds of computing and that controls the entire digital still camera, and a timing generator 1008 that outputs various kinds of timing signals to the imaging device 1004 and the signal processor 1007. A timing signal and the like may be input from the outside, and the photoelectric conversion system may at least include the imaging device 1004 and the signal processor 1007 that processes an output signal output from the imaging device 1004.

The imaging device 1004 outputs an imaging signal to the signal processor 1007. The signal processor 1007 performs predetermined signal processing on the imaging signal output from the imaging device 1004, and outputs image data. The signal processor 1007 uses the imaging signal to generate an image.

Accordingly, this embodiment can achieve a photoelectric conversion system using the photoelectric conversion device (imaging device) according to any of the above embodiments.

### Eighth Embodiment

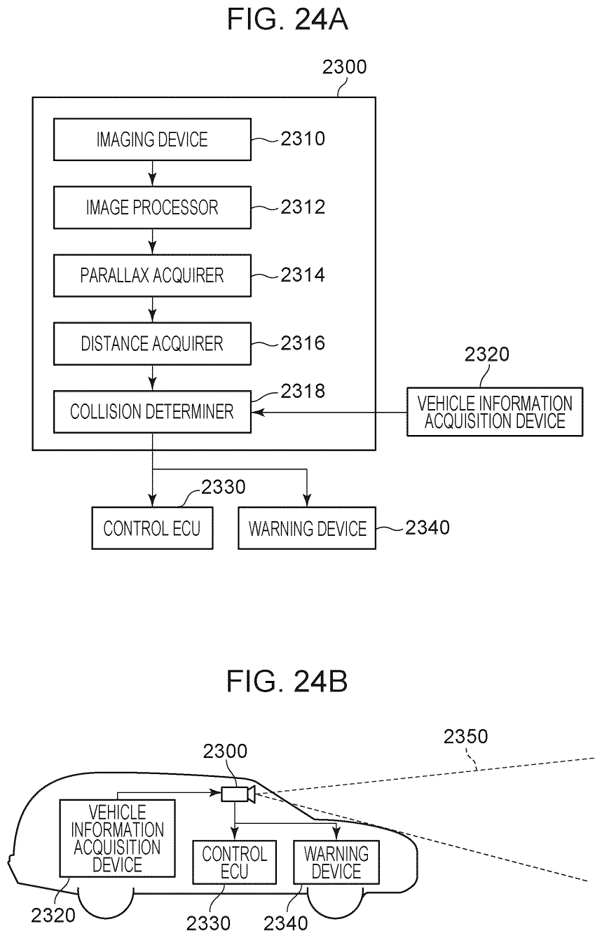

A photoelectric conversion system and a mobile object according to this embodiment will now be described with reference to FIGS. 24A and 24B. FIGS. 24A and 24B illustrate the configurations of the photoelectric conversion system and the mobile object according to this embodiment.

FIG. 24A illustrates an example of a photoelectric conversion system related to an in-vehicle camera. A photoelectric conversion system 2300 includes an imaging device 2310. The imaging device 2310 is the photoelectric conversion device according to any of the above embodiments. The photoelectric conversion system 2300 includes an image processor 2312 that performs image processing on multiple pieces of image data acquired by the imaging device 2310. The photoelectric conversion system 2300 further includes a parallax acquirer 2314 that calculates a parallax (i.e., a phase difference of parallax images) from the multiple pieces of image data acquired by the photoelectric conversion system 2300. Furthermore, the photoelectric conversion system 2300 includes a distance acquirer 2316 that calculates a distance to a target object based on the calculated parallax, and a collision determiner 2318 that determines whether there is a possibility of a collision based on the calculated distance. The parallax acquirer 2314 and the distance acquirer 2316 are an example of a distance information acquisition unit that acquires distance information to a target object. Specifically, the distance information may be acquired by using not only a phase difference but also the time-of-flight (ToF) technology. The collision determiner 2318 may determine a possibility of a collision by using either of these pieces of distance information. The distance information acquisition unit may be realized by dedicatedly-designed hardware, or may be implemented by a software module. Alternatively, the distance information acquisition unit may be realized by, for example, a field programmable gate array (FPGA), an application specific integrated circuit (ASIC), or a combination thereof.

The photoelectric conversion system 2300 is connected to a vehicle information acquisition device 2320, and can acquire vehicle information, such as the vehicle speed, yaw rate, and steering angle. The photoelectric conversion system 2300 is connected to a control electronic control unit (ECU) 2330 serving as a control device (controller) that outputs a control signal for causing a vehicle to generate a braking force based on a determination result obtained by the collision determiner 2318. Moreover, the photoelectric conversion system 2300 is also connected to a warning device 2340 that issues a warning to a driver based on the determination result obtained by the collision determiner 2318. For example, when the determination result obtained by the collision determiner 2318 indicates a high possibility of a collision, the control ECU 2330 performs vehicle control to avoid the collision or mitigate damage by applying a braking force, releasing the accelerator, suppressing engine output, or the like.

The warning device 2340 warns the user by, for example, issuing an audible alarm or the like, displaying warning information on a screen of a car navigation system or the like, and/or vibrating the seatbelt and/or the steering wheel.

In this embodiment, the photoelectric conversion system 2300 captures an image of an area surrounding the vehicle, such as image of an area forward or rearward of the vehicle. The photoelectric conversion system illustrated in FIG. 24B relates to a case where an image of an area forward of the vehicle (imaging range 2350) is to be captured. The vehicle information acquisition device 2320 transmits a command to the photoelectric conversion system 2300 or the imaging device 2310. With such a configuration, the accuracy of distance measurement can be further improved.

Although the above description relates to an example where control is performed to avoid a collision with another vehicle, the photoelectric conversion system is applicable to autonomous driving control for following another vehicle or autonomous driving control for preventing lane departure. Moreover, the photoelectric conversion system is not limited to a vehicle, such as a host vehicle, and is applicable to, for example, a mobile object (mobile apparatus), such as a vessel, an aircraft, or an industrial robot. In addition, the photoelectric conversion system is not limited to a mobile object, and is applicable to an apparatus that widely utilizes object recognition, such as an intelligent transport system (ITS).

### Ninth Embodiment

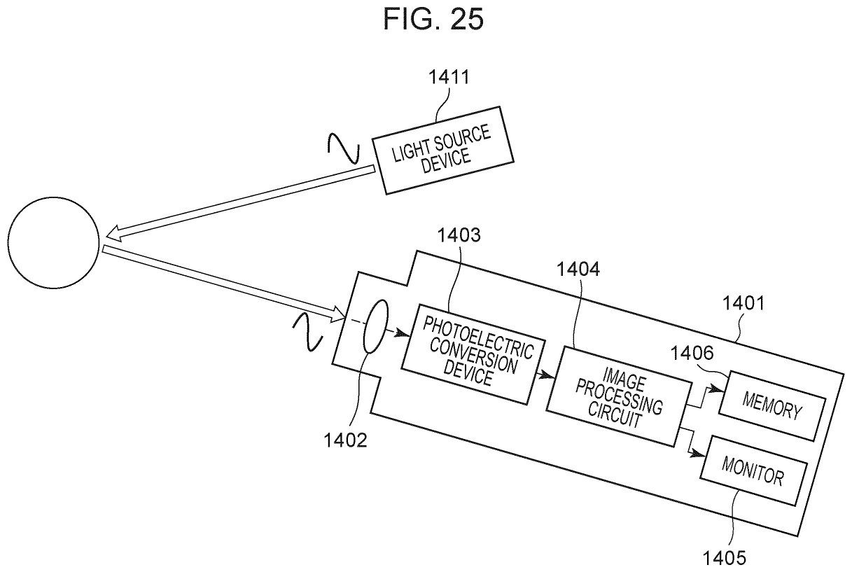

A photoelectric conversion system according to this embodiment will now be described with reference to FIG. 25. FIG. 25 is a block diagram illustrating a configuration example of a distance image sensor serving as the photoelectric conversion system.

As illustrated in FIG. 25, a distance image sensor 1401 includes an optical system 1402, a photoelectric conversion device 1403, an image processing circuit 1404, a monitor 1405, and a memory 1406. The distance image sensor 1401 receives light (modulated light or pulsed light) projected from a light source device 1411 toward a subject and reflected by the surface of the subject, so as to acquire a distance image according to the distance to the subject.

The optical system 1402 includes one or more lenses, guides image light (incident light) from the subject to the photoelectric conversion device 1403, and causes an image to form on a light receiving surface (sensor) of the photoelectric conversion device 1403.

The photoelectric conversion device 1403 is the photoelectric conversion device according to any of the above embodiments. A distance signal indicating a distance determined from a light reception signal output from the photoelectric conversion device 1403 is supplied to the image processing circuit 1404.

The image processing circuit 1404 performs image processing involving forming a distance image based on the distance signal supplied from the photoelectric conversion device 1403. The distance image (image data) obtained as a result of the image processing is supplied to the monitor 1405 so as to be displayed thereon, or is supplied to the memory 1406 so as to be stored (recorded) therein.

The distance image sensor 1401 having this configuration uses the aforementioned photoelectric conversion device to achieve improved pixel characteristics, thereby acquiring, for example, a more accurate distance image.

### Tenth Embodiment

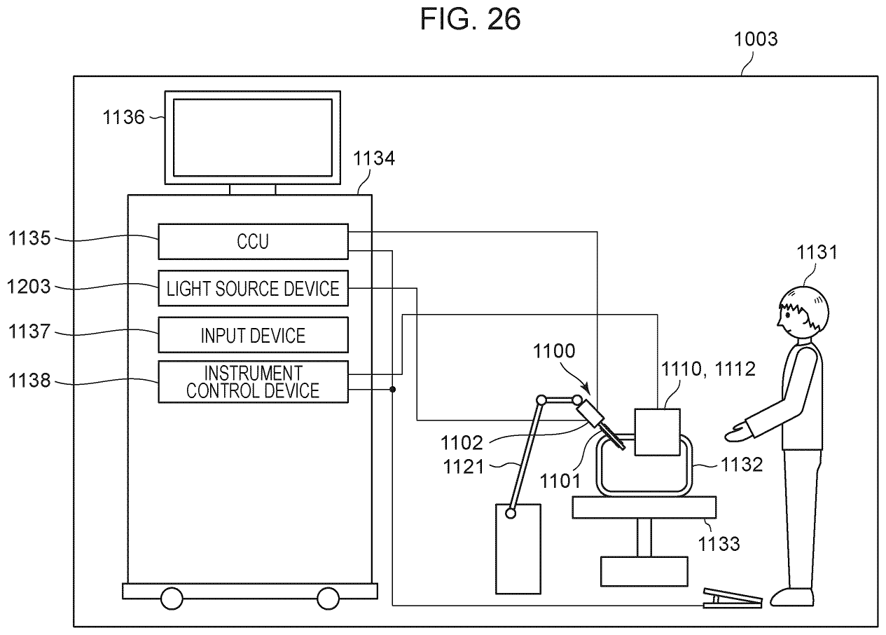

A photoelectric conversion system according to this embodiment will now be described with reference to FIG. 26. FIG. 26 illustrates an example of a schematic configuration of an endoscopic surgical system serving as the photoelectric conversion system according to this embodiment.

In FIG. 26, a surgeon (doctor) 1131 is performing surgery on a patient 1132 on a patient bed 1133 by using an endoscopic surgical system 1103. As illustrated in FIG. 26, the endoscopic surgical system 1103 includes an endoscope 1100, a surgical instrument 1110, and a cart 1134 equipped with various devices for endoscopic surgery.

The endoscope 1100 includes a lens barrel 1101 whose area with a predetermined length from the distal end thereof is to be inserted into the body cavity of the patient 1132, and a camera head 1102 connected to the base end of the lens barrel 1101. Although the endoscope 1100 in the example illustrated in FIG. 26 is a so-called rigid endoscope having the lens barrel 1101 that is rigid, the endoscope 1100 may be a so-called flexible endoscope having a flexible lens barrel.

The distal end of the lens barrel 1101 is provided with an opening in which an objective lens is fitted. The endoscope 1100 is connected to a light source device 1203. Light generated by the light source device 1203 is optically guided to the distal end of the lens barrel 1101 by a light guide extending into the lens barrel 1101, and is radiated toward an observation target within the body cavity of the patient 1132 via the objective lens. The endoscope 1100 may be a forward-viewing endoscope, an oblique-viewing endoscope, or a side-viewing endoscope.

An optical system and a photoelectric conversion device are provided inside the camera head 1102, and reflected light (observation light) from the observation target is focused onto the photoelectric conversion device by the optical system. The observation light undergoes photoelectric conversion by the photoelectric conversion device, so that an electrical signal corresponding to the observation light, that is, an image signal corresponding to an observation image, is generated. The photoelectric conversion device used may be the photoelectric conversion device according to any of the above embodiments. The image signal is transmitted as raw data to a camera control unit (CCU) 1135.

The CCU 1135 is constituted of a central processing unit (CPU), a graphics processing unit (GPU), or the like, and centrally controls the operation of the endoscope 1100 and a display device 1136. Furthermore, the CCU 1135 receives the image signal from the camera head 1102, and performs various kinds of image processing, such as development processing (demosaicing), on the image signal for displaying an image based on the image signal.

By being controlled by the CCU 1135, the display device 1136 displays the image based on the image signal image-processed by the CCU 1135.

The light source device 1203 includes a light source, such as a light emitting diode (LED), and supplies irradiation light to the endoscope 1100 when a surgical site is to be imaged.

An input device 1137 is an input interface for the endoscopic surgical system 1103. A user can input various types of information or a command to the endoscopic surgical system 1103 via the input device 1137.

An instrument control device 1138 controls the driving of an energy treatment instrument 1112 for cauterizing tissue, incising tissue, sealing a blood vessel, or the like.

The light source device 1203 that supplies irradiation light when a surgical site is to be imaged in the endoscope 1100 may be constituted of, for example, a white light source including an LED, a laser light source, or a combination thereof. If the white light source is constituted of a combination of R, G, and B laser light sources, the output intensities and the output timings of the respective colors (respective wavelengths) can be controlled with high accuracy, so that the white balance of a captured image can be adjusted in the light source device 1203. Moreover, in this case, the laser beams from the R, G, and B laser light sources may be radiated onto the observation target in a time-division manner, and the driving of an imaging element of the camera head 1102 may be controlled in synchronization with the irradiation timings of the laser beams, whereby images corresponding to the respective R, G, and B colors can be captured in a time-division manner. With this method, a color image can be obtained without having to provide the imaging element with a color filter.

The driving of the light source device 1203 may be controlled such that the intensity of light to be output changes every predetermined time period. By controlling the driving of the imaging element of the camera head 1102 in synchronization with the timing for changing the light intensity, acquiring images in a time-division manner, and combining the images, a so-called high-dynamic-range image without black crush or white clipping can be generated.

The light source device 1203 may be capable of supplying light in a predetermined wavelength band corresponding to special light observation. In special light observation, for example, wavelength dependence of light absorption in body tissue is utilized. In detail, the light to be radiated is in a narrower band than the irradiation light (i.e., white light) used in normal observation, so that predetermined tissue, such as superficial mucosal vessels, is captured with high contrast.

Alternatively, special light observation may involve performing fluorescence observation to obtain an image from fluorescence occurring as a result of radiating excitation light. Fluorescence observation may involve, for example, irradiating body tissue with excitation light and observing fluorescence from the body tissue, or obtaining a fluorescence image by locally injecting a reagent, such as indocyanine green (ICG), into the body tissue and irradiating the body tissue with excitation light corresponding to the fluorescence wavelength of the reagent. The light source device 1203 may be capable of supplying narrow-band light and/or excitation light corresponding to such special light observation.

### Eleventh Embodiment

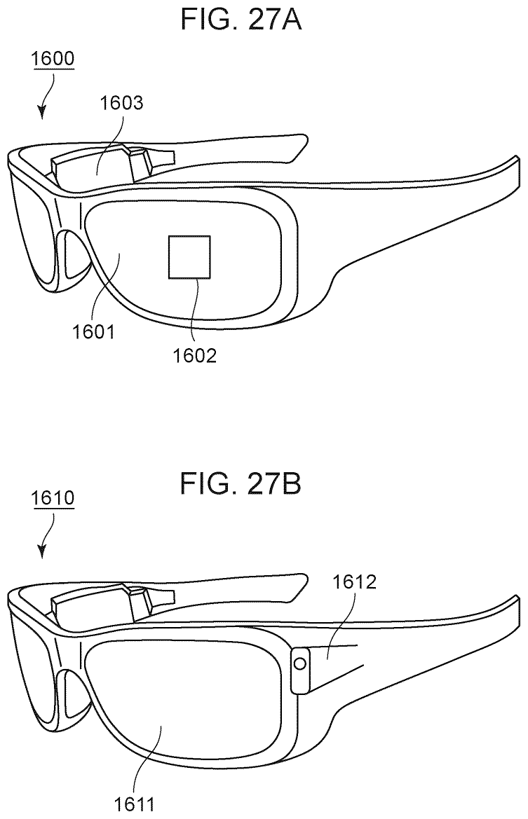

A photoelectric conversion system according to this embodiment will now be described with reference to FIGS. 27A and 27B. FIG. 27A illustrates an example of the configuration of a pair of glasses (smartglasses) 1600 serving as the photoelectric conversion system.

The pair of glasses 1600 includes a photoelectric conversion device 1602. The photoelectric conversion device 1602 is the photoelectric conversion device according to any of the above embodiments. The rear surface of a lens 1601 may be provided with a display device including a light emitting device, such as an organic LED (OLED) or an LED. The photoelectric conversion device 1602 may be a single device or multiple devices. Moreover, multiple types of photoelectric conversion devices may be used in combination. The placement position of the photoelectric conversion device 1602 is not limited to that in FIG. 27A.

The pair of glasses 1600 further includes a control device 1603. The control device 1603 functions as a power supply that supplies electric power to the photoelectric conversion device 1602 and the aforementioned display device. The control device 1603 also controls the operation of the photoelectric conversion device 1602 and the display device. The lens 1601 is provided with an optical system for focusing light onto the photoelectric conversion device 1602.

FIG. 27B illustrates a pair of glasses (smartglasses) 1610 according to one application example. The pair of glasses 1610 includes a control device 1612. The control device 1612 is equipped with a photoelectric conversion device equivalent to the photoelectric conversion device 1602, as well as a display device. A lens 1611 is provided with an optical system for projecting light emitted from the photoelectric conversion device within the control device 1612 and from the display device, so that an image is projected onto the lens 1611. The control device 1612 functions as a power supply that supplies electric power to the photoelectric conversion device and the display device, and also controls the operation of the photoelectric conversion device and the display device. The control device 1612 may include a line-of-sight detector that detects the line of sight of a wearer. For the detection of the line of sight, infrared light may be used. An infrared emitter emits infrared light toward an eyeball of a user gazing at a display image. An imager having a photoelectric conversion element detects reflected light originating from the emitted infrared light and coming from the eyeball, so as to obtain a captured image of the eyeball. A reducing unit is provided to reduce light from the infrared emitter to a display unit in plan view, thereby suppressing a decrease in image quality.

The line of sight of the user relative to the display image is detected from the captured eyeball image obtained by imaging the infrared light. For the line-of-sight detection using the captured eyeball image, any known technique may be used. One example that can be used is a line-of-sight detection method based on a Purkinje image obtained by reflection of irradiation light at the cornea.

More specifically, a line-of-sight detection process based on the pupil center corneal reflection method is performed. The pupil center corneal reflection method is used to calculate a line-of-sight vector expressing the orientation (rotation angle) of the eyeball based on a pupil image and a Purkinje image included in the captured eyeball image, whereby the line of sight of the user is detected.

The display device in this embodiment may include a photoelectric conversion device including a photoelectric conversion element, and may control the display image of the display device based on line-of-sight information of the user from the photoelectric conversion device.

In detail, based on the line-of-sight information, the display device sets a first field-of-view region at which the user gazes, and a second field-of-view region other than the first field-of-view region. The first field-of-view region and the second field-of-view region may be set by a control device of the display device, or the set field-of-view regions may be received from an external control device. The display region of the display device may be controlled such that the display resolution in the first field-of-view region is higher than the display resolution in the second field-of-view region. In other words, the resolution in the second field-of-view region may be lower than that in the first field-of-view region.

Furthermore, the display region may include a first display region and a second display region different from the first display region. Based on the line-of-sight information, a high-priority region may be selected from the first display region and the second display region. The first field-of-view region and the second field-of-view region may be set by the control device of the display device, or the set field-of-view regions may be received from an external control device. The resolution in the high-priority region may be controlled to be higher than the resolution in a region other than the high-priority region. In other words, the resolution in a region with a relatively low priority level may be reduced.

For setting the first field-of-view region or the high-priority region, artificial intelligence (AI) may be used. AI may be a model that uses an image of an eyeball and an actual viewing direction of the eyeball in the image as training data to estimate the angle of the line of sight and the distance to a visual target from the eyeball image. An AI program may be included in the display device, the photoelectric conversion device, or an external device. If the AI program is included in the external device, the AI program is transmitted to the display device via communication.

If display control is to be performed based on visibility detection, the embodiment may be applied to a pair of smartglasses further including a photoelectric conversion device that captures an external image. The pair of smartglasses can display captured external image information in real time.

The embodiments described above may be appropriately modified without departing from the technical spirit. An example obtained by adding a partial configuration of any of the embodiments to another embodiment or an example obtained by replacing a partial configuration with that in another embodiment is also included in the embodiments of the present disclosure.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-226059, filed Dec. 23, 2024, which is hereby incorporated by reference herein in its entirety.

What is claimed is:

1. A conversion device comprising:
a photoelectric conversion element configured to receive a photon;
a first controller configured to generate a signal defining a plurality of second periods that are included in a first period corresponding to one frame, each second period being shorter than the first period;
a generator configured to generate a pulse signal that defines time information within each second period;
a measurer configured to count the pulse signal at or after first photon detection in the second period based on the generated pulse signal; and
a second controller configured to perform count control of the pulse signal in a subsequent second period to the second period based on a value of the measurer, the subsequent second period being one of the plurality of second periods.

2. The conversion device according to claim 1,
wherein the second controller performs the count control of the pulse signal in the subsequent second period by selecting the pulse signal from a plurality of pulse signals.

3. The conversion device according to claim 1,
wherein when the value of the measurer is smaller than a predetermined value, the pulse signal in the subsequent second period is increased in number relative to the pulse signal in the second period.

4. The conversion device according to claim 1,
wherein when the value of the measurer is larger than a predetermined value, the pulse signal in the subsequent second period is reduced in number relative to the pulse signal in the second period.

5. The conversion device according to claim 1,
wherein the generator generates the pulse signal having a uniform interval, and
wherein the pulse signal is input to the measurer at least in the second period.

6. The conversion device according to claim 1,
wherein the generator generates the pulse signal having a nonuniform interval, and
wherein the pulse signal is input to the measurer at least in the second period.

7. The conversion device according to claim 6,
wherein the pulse signal having the nonuniform interval is configured such that a period thereof increases in accordance with an elapsed time in the second period.

8. The conversion device according to claim 7,
wherein the pulse signal having the nonuniform interval has an interval set to be a logarithmic compression of real time.

9. The conversion device according to claim 1, further comprising:
a correction circuit configured to correct a signal output from the measurer,
wherein the correction circuit changes a correction method based on a count value of the pulse signal.

10. The conversion device according to claim 4, further comprising:
a correction circuit configured to correct a signal output from the measurer,
wherein when the pulse signal in the subsequent second period is reduced in number relative to the pulse signal in the second period, the correction circuit changes the value output from the measurer to a larger value.

11. The conversion device according to claim 1,
wherein the measurer includes a waveform shaping circuit that converts a signal from the photoelectric conversion element into a pulse signal, a timing determination circuit, and a counter circuit,
wherein the timing determination circuit outputs the pulse signal generated by the generator at or after a timing of the first photon detection within the second period; and
wherein the counter circuit obtains a count value by performing a count for every input of the pulse signal output from the timing determination circuit within the second period.

12. The conversion device according to claim 11,
wherein the counter circuit obtains a sum value by adding together the count values from the plurality of second periods and outputs the sum value.

13. The conversion device according to claim 1,
wherein the photoelectric conversion element is an avalanche photodiode.

14. The conversion device according to claim 13,
wherein a switch configured to perform a charging operation is disposed between the avalanche photodiode and a power supply that applies a reverse bias to the avalanche photodiode, and
wherein each second period is a period from a timing at which the charging operation is performed to a timing at which the charging operation is subsequently performed.

15. The conversion device according to claim 1,
wherein the measurer includes a selection circuit, and
wherein the plurality of second periods include a first one of the second periods and a second one of the second periods, and
wherein the selection circuit selects whether or not to output a signal corresponding to the pulse signal that defines the time information within the second one of the second periods between when the photon is not detected in the first one of the second periods and when the photon is detected in the first one of the second periods.

16. The conversion device according to claim 15,
wherein when the photon is not detected in the first one of the second periods, the selection circuit outputs a predetermined value regardless of a time period from a start of the second one of the second periods to the first photon detection.

17. The conversion device according to claim 1,
wherein a first substrate and a second substrate are stacked,
wherein the first substrate includes the photoelectric conversion element, and
wherein the second substrate includes the first controller, the generator, the measurer, and the second controller.

18. The conversion device according to claim 11,
wherein a first substrate, a second substrate, and a third substrate are stacked,
wherein the first substrate includes the photoelectric conversion element,
wherein the second substrate includes the waveform shaping circuit, the timing determination circuit, the counter circuit, and the second controller, and
wherein the third substrate includes a second timing determination circuit, a second counter circuit, and a third controller.

19. The conversion device according to claim 18,
wherein a pulse signal that is generated by the generator and that is to be input to the timing determination circuit included in the second substrate is different from a pulse signal that is generated by the generator and that is to be input to the second timing determination circuit included in the third substrate.

20. A conversion system comprising:
the conversion device according to claim 1; and
a signal processor configured to generate an image by using a signal output from the conversion device.
